(19) United States
(12) Patent Application Publication
(10) Pub. No.: US 2025/0389988 A1
(43) Pub. Date: Dec. 25, 2025

(54) LAMINATE

(71) Applicant: FUJIFILM Corporation, Tokyo (JP)

(72) Inventors: Shinichi YOSHINARI, Kanagawa (JP); Naoya NISHIMURA, Kanagawa (JP); Naoki KOITO, Kanagawa (JP)

(73) Assignee: FUJIFILM Corporation, Tokyo (JP)

(21) Appl. No.: 19/306,726

(22) Filed: Aug. 21, 2025

Related U.S. Application Data
(63) Continuation of application No. PCT/JP2024/009324, filed on Mar. 11, 2024.

(30) Foreign Application Priority Data
Mar. 28, 2023 (JP) 2023-051111

(51) Int. Cl. G02F 1/1337

(52) U.S. Cl. CPC G02F 1/133742

(57) ABSTRACT

A laminate including a light absorption anisotropic layer, in which flexibility is improved even in a case of being applied to a bending application. The laminate includes a protective layer, a light absorption anisotropic layer, an alignment film, and a bonding layer in this order, in which the light absorption anisotropic layer contains a dichroic substance, a liquid crystal compound, and a vertical alignment agent, an angle θ between a transmittance central axis of the light absorption anisotropic layer and a normal direction of a surface of the light absorption anisotropic layer is 0° or more and 45° or less, and the bonding layer is a pressure sensitive adhesive layer or an adhesive layer.

### CROSS-REFERENCE TO RELATED APPLICATIONS

This application is a Continuation of PCT International Application No. PCT/JP2024/009324 filed on Mar. 11, 2024, which was published under PCT Article 21(2) in Japanese, and which claims priority under 35 U.S.C. § 119(a) to Japanese Patent Application No. 2023-051111 filed on Mar. 28, 2023. The above applications are hereby expressly incorporated by reference, in their entirety, into the present application.

### BACKGROUND OF THE INVENTION

### 1. Field of the Invention

The present invention relates to a laminate.

### 2. Description of the Related Art

An image display device such as a liquid crystal display device and an organic electroluminescence (hereinafter, abbreviated as “EL”) display device is widely used as a display of a smartphone, a notebook computer, or the like. In recent years, since these devices have been thinner and lighter and are thus easily carried, the devices are used in public places, for example, transportation facilities such as trains and aircraft, libraries, and restaurants in many cases. Therefore, due to the need to protect personal information, confidential information, and the like, there is a demand for a technique for preventing the display contents of image display devices from being peeped by others.

As a technique of controlling such a viewing angle, for example, WO2022-270466A describes “an optical film including a light absorption anisotropic layer containing a liquid crystal compound and a dichroic substance, in which an angle θ between a transmittance central axis of the light absorption anisotropic layer and a normal direction of a surface of the light absorption anisotropic layer is 0° or more and 45° or less, and a haze value of the optical film is more than 1% and 20% or less” ([Claim 1]).

In addition, WO2023-276679A discloses a light absorption anisotropic layer formed of a liquid crystal composition containing a liquid crystal compound, a dichroic substance, and an alignment agent, in which the liquid crystal compound is a liquid crystal compound exhibiting a liquid crystal state of a smectic phase, a content of the dichroic substance is 5.0% by mass or more with respect to a total solid content mass of the liquid crystal composition, and an angle θ between a transmittance central axis of the light absorption anisotropic layer and a normal direction of a surface of the light absorption anisotropic layer is 0° or more and 45° or less ([claim 1]).

### SUMMARY OF THE INVENTION

As a result of studying the laminates having the light absorption anisotropic layer described in WO2022-270466A and WO2023-276679A, the present inventors have found that there is room for improvement in flexibility in a case of being applied to a use application (hereinafter, abbreviated as “bending use application”) in which bending occurs in a member such as a foldable display or a curved display.

Therefore, an object of the present invention is to provide a laminate including a light absorption anisotropic layer, in which flexibility is improved even in a case of being applied to a bending application.

As a result of intensive studies to achieve the above-described object, the inventors of the present invention have found that, by using a laminate having a protective layer, a light absorption anisotropic layer, an alignment film, and a bonding layer adjacent to each other in this order, flexibility is improved even when applied to a bending application, and have completed the present invention.

That is, the present inventors have found that the above-described object can be achieved by employing the following configurations.

[1]A laminate including a protective layer, a light absorption anisotropic layer, an alignment film, and a bonding layer, which are adjacent to each other in this order, in which the light absorption anisotropic layer contains a dichroic substance, a liquid crystal compound, and a vertical alignment agent, an angle θ between a transmittance central axis of the light absorption anisotropic layer and a normal direction of a surface of the light absorption anisotropic layer is 0° or more and 45° or less, and the bonding layer is a pressure sensitive adhesive layer or an adhesive layer.

[2] The laminate according to [1], in which the light absorption anisotropic layer is a layer formed by fixing an alignment state of a liquid crystal composition containing the dichroic substance, the liquid crystal compound, the vertical alignment agent, and an additive having a crosslinkable group.

[3] The laminate according to [2], in which the crosslinkable group is an active hydrogen reactive group, and the vertical alignment agent is an ionic vertical alignment agent.

[4] The laminate according to any one of [1] to [3], in which the vertical alignment agent includes an ionic vertical alignment agent and a vertical alignment agent having a boronic acid group.

[5] The laminate according to any one of [1] to [4], in which at least one of the protective layer or the alignment film contains an additive having an active hydrogen reactive group.

[6] The laminate according to any one of [1] to [5], in which a content of the dichroic substance contained in the light absorption anisotropic layer is 20 to 650 mg/cm³.

[7] The laminate according to any one of [1] to [6], in which an alignment degree of the light absorption anisotropic layer at a wavelength of 550 nm is 0.90 or more.

[8] The laminate according to any one of [1] to [7], in which a difference in alignment degree of the light absorption anisotropic layer at wavelengths of 450 nm, 550 nm, and 650 nm is 0.025 or less.

[9] The laminate according to any one of [1] to [8], in which a haze value of the light absorption anisotropic layer is 0.3% or less.

[10] The laminate as described in any one of [1] to [9], in which a thickness of the light absorption anisotropic layer is 1.5 μm or more.

[11] The laminate according to [2] or [3], in which the dichroic substance contained in the liquid crystal composition is a compound having a polymerizable group.

[12] The laminate according to any one of [1] to [11], in which at least one of the protective layer or the alignment film is any of a polyvinyl alcohol-based resin or an acrylate-based resin.

[13] The laminate according to any one of [1] to [12], in which the alignment film contains any one of a polyvinyl alcohol-based resin, a cinnamoyl group-containing resin, or an epoxy resin.

[14] The laminate according to any one of [1] to [13], in which the protective layer is an acrylic resin film consisting of a polymer of a polyfunctional (meth)acrylate.

[15] The laminate according to any one of [1] to [14], further including at least one layer of a polarizer layer, an antireflection layer, or a retardation layer.

[16] The laminate according to [15], in which the polarizer layer is a coating type polarizer layer.

According to the present invention, it is possible to provide a laminate including a light absorption anisotropic layer, in which flexibility is improved even when applied to a bending application.

### BRIEF DESCRIPTION OF THE DRAWINGS

FIG. 1 is a schematic view showing an example of a head-mounted display (hereinafter, also referred to as a “head-mounted display of the present invention”) having a laminate of the present invention.

FIG. 2 is a schematic diagram showing an example of a configuration of a light guide plate for an augmented reality (AR) glass.

FIG. 3 is a schematic diagram showing a plan view of an evaluation system of the head-mounted display according to the embodiment of the present invention.

FIG. 4 is a schematic diagram showing an elevation view of an evaluation system of the head-mounted display according to the embodiment of the present invention.

### DESCRIPTION OF THE PREFERRED EMBODIMENTS

Hereinafter, the present invention will be described in detail.

The following description of configuration requirements is based on representative embodiments of the present invention, but the present invention is not limited to the embodiments.

In the present specification, a numerical range expressed using “to” means a range including numerical values before and after “to” as a lower limit value and an upper limit value.

In addition, in the present specification, an upper limit value or a lower limit value described in a certain numerical range in a numerical range described in a stepwise manner may be replaced with an upper limit value or a lower limit value in another numerical range described in a stepwise manner. In addition, regarding the numerical range described in the present specification, an upper limit value or a lower limit value described in a numerical value may be replaced with a value described in Examples.

In addition, in the present specification, the terms parallel and orthogonal do not mean only strict parallel and strict orthogonal, respectively, but rather a range of parallel ±5° and a range of orthogonal ±5°, respectively.

In addition, in the present specification, as each component, a substance corresponding to each component may be used alone, or two or more kinds of substances may be used in combination. Here, in a case where two or more kinds of substances are used in combination for each component, the content of the component refers to a total content of the substances used in combination unless otherwise specified.

In addition, in the present specification, “(meth)acrylate” represents “acrylate” or “methacrylate”, “(meth)acryl” represents “acryl” or “methacryl”, and “(meth)acryloyl” represents “acryloyl” or “methacryloyl”.

In addition, in the present specification, Re(λ) and Rth(λ) respectively represent an in-plane retardation at a wavelength λ and a thickness-direction retardation at a wavelength λ. Unless otherwise specified, the wavelength λ is 550 nm.

In the present invention, Re(λ) and Rth(λ) are values measured at the wavelength of λ in AxoScan (manufactured by Axometrics, Inc.). By inputting an average refractive index ((nx+ny+nz)/3) and a film thickness (d (μm)) in AxoScan, Slow axis direction (°),

$$Re ( λ ) = R 0 ( λ ) , and$$

$$Rth ( λ ) = ( ( nx + ny ) / 2 - nz ) \times d$$

are calculated.

R0(λ) is expressed as a numerical value calculated by AxoScan and represents Re(λ).

In the present specification, the refractive indices nx, ny, and nz are measured using an Abbe refractometer (NAR-4T, manufactured by Atago Co., Ltd.) and a sodium lamp (λ=589 nm) as a light source. In addition, in the measurement of wavelength dependence, it can be measured with a multi-wavelength Abbe refractometer DR-M2 (manufactured by Atago Co., Ltd.) in combination with a dichroic filter.

In addition, values in Polymer Handbook (John Wiley & Sons, Inc.) and catalogs of various optical films can be used. Examples of values of the average refractive indices of main optical films are as follows: cellulose acylate (1.48), cycloolefin polymer (1.52), polycarbonate (1.59), polymethylmethacrylate (1.49), and polystyrene (1.59).

### [Laminate]

The laminate according to the embodiment of the present invention includes a protective layer, a light absorption anisotropic layer, an alignment film, and a bonding layer in this order in an adjacent manner.

In addition, the light absorption anisotropic layer of the laminate according to the embodiment of the present invention contains a dichroic substance, a liquid crystal compound, and a vertical alignment agent, and an angle θ between a transmittance central axis of the light absorption anisotropic layer and a normal direction of a surface of the light absorption anisotropic layer is 0° or more and 45° or less.

In addition, the bonding layer in the laminate according to the embodiment of the present invention is a pressure sensitive adhesive layer or an adhesive layer.

Here, the transmittance central axis of the light absorption anisotropic layer means a direction in which the highest transmittance is exhibited in a case where the transmittance is measured by changing the inclination angle (polar angle) and the inclination direction (azimuthal angle) with respect to the normal direction of the surface of the light absorption anisotropic layer.

Specifically, the Mueller matrix at a wavelength of 550 nm is measured using AxoScan (OPMF-2, manufactured by Axometrics, Inc.). More specifically, in the measurement, an azimuthal angle at which the transmittance central axis is inclined is first searched for, the Mueller matrix at a wavelength of 550 nm is measured while the polar angle which is the angle with respect to the normal direction of the surface of the light absorption anisotropic layer is changed from −70° to 70° at intervals of 1° in the surface (the plane that has the transmittance central axis and is orthogonal to the layer surface) having the normal direction of the light absorption anisotropic layer along the azimuthal angle, and the transmittance of the light absorption anisotropic layer is derived. As a result, the direction in which the highest transmittance is exhibited is defined as the transmittance central axis.

Further, the transmittance central axis means a direction (the major axis direction of a molecule) of the absorption axis of the dichroic substance contained in each light absorption anisotropic layer.

In the present invention, as described above, by using a laminate having a protective layer, a light absorption anisotropic layer, an alignment film, and a bonding layer adjacent to each other in this order, the flexibility is improved even in a case of being applied to a bending application.

The reason why this effect is exhibited is not clear in detail, but the present inventors have presumed as follows.

That is, the laminate according to the embodiment of the present invention is different from the above-described well-known laminate in the related art as shown in Comparative Example 1, that is, the laminate having a support between the alignment film and the bonding layer, in that the presence or absence of the support is different.

Therefore, in the present invention, it is considered that the flexibility is improved by not providing the support between the alignment film and the bonding layer.

Hereinafter, each layer configuration of the laminate according to the embodiment of the present invention will be described in detail.

### [Protective Layer]

From the viewpoint of suppressing mutual diffusion of components such as a dichroic substance contained in the light absorption anisotropic layer, the protective layer of the laminate according to the embodiment of the present invention is a layer provided as an adjacent layer to the light absorption anisotropic layer.

As the protective layer, a resin film is preferably used.

Examples of the resin film include a PVA-based resin film consisting of polyvinyl alcohol (PVA) or a derivative thereof, an acrylic resin film consisting of a polymer of a polyfunctional (meth)acrylate, an epoxy-based resin film, a cellulose ester-based resin film, a polyethylene terephthalate resin film, and a polycarbonate resin film.

In the present invention, from the reason that the flexibility is further improved, among the examples of the resin film described above, a PVA-based resin film or an acrylic resin film consisting of a polymer of a polyfunctional (meth)acrylate is more preferable.

The thickness of the protective layer is not particularly limited, but is preferably 0.01 to 10 μm, more preferably 0.05 to 5 μm, and still more preferably 0.1 to 2 μm.

### [Light Absorption Anisotropic Layer]

The light absorption anisotropic layer of the laminate according to the embodiment of the present invention is a layer containing a dichroic substance, a liquid crystal compound, and a vertical alignment agent.

In addition, an angle θ (hereinafter, also referred to as a “transmittance central axis angle θ”) formed by a transmittance central axis of the light absorption anisotropic layer and a normal direction of a surface of the light absorption anisotropic layer is 0° or more and 45° or less, preferably 0° or more and less than 45°, more preferably 0° or more and 35° or less, and still more preferably 0° or more and less than 35°.

### <Dichroic Substance>

The light absorption anisotropic layer contains a dichroic substance.

Here, the dichroic substance means a coloring agent having different absorbances depending on the direction. The dichroic substance may or may not exhibit liquid crystallinity.

The dichroic substance is not particularly limited, and examples thereof include a visible light absorbing substance (dichroic coloring agent), a light emitting substance (fluorescent substance and phosphorescent substance), an ultraviolet absorbing substance, an infrared absorbing substance, a non-linear optical substance, a carbon nanotube, and an inorganic substance (for example, quantum rod). Further, known dichroic substances (dichroic coloring agents) of the related art can be used.

Specific examples thereof include those described in paragraphs [0067] to [0071] of JP2013-228706A, paragraphs [0008] to [0026] of JP2013-227532A, paragraphs [0008] to [0015] of JP2013-209367A, paragraphs [0045] to [0058] of JP2013-14883A, paragraphs [0012] to [0029] of JP2013-109090A, paragraphs [0009] to [0017] of JP2013-101328A, paragraphs [0051] to [0065] of JP2013-37353A, paragraphs [0049] to [0073] of JP2012-63387A, paragraphs [0016] to [0018] of JP1999-305036A (JP-H11-305036A), paragraphs [0009] to [0011] of JP2001-133630A, paragraphs [0030] to [0169] of JP2011-215337A, paragraphs [0021] to [0075] of JP2010-106242A, paragraphs [0011] to [0025] of JP2010-215846A, paragraphs [0017] to [0069] of JP2011-048311A, paragraphs [0013] to [0133] of JP2011-213610A, paragraphs [0074] to [0246] of JP2011-237513A, paragraphs [0005] to [0051] of JP2016-006502A, paragraphs [0014] to [0032] of JP2018-053167A, paragraphs [0014] to [0033] of JP2020-11716A, paragraphs [0005] to [0041] of WO2016/060173A, paragraphs [0008] to [0062] of WO2016/136561A, paragraphs [0014] to [0033] of WO2017/154835A, paragraphs [0014] to [0033] of WO2017/154695A, paragraphs [0013] to [0037] of WO2017/195833A, paragraphs [0014] to [0034] of WO2018/164252A, paragraphs [0021] to [0030] of WO2018/186503A, paragraphs [0043] to [0063] of WO2019/189345A, paragraphs [0043] to [0085] of WO2019/225468A, paragraphs [0050] to [0074] of WO2020/004106A, and paragraphs [0015] to [0038] of WO2021/044843A.

As the dichroic substance, a dichroic azo coloring agent compound is preferable. The dichroic azo coloring agent compound means an azo coloring agent compound having different absorbances depending on directions. The dichroic azo coloring agent compound may or may not exhibit liquid crystallinity. In a case where the dichroic azo coloring agent compound exhibits liquid crystallinity, any of nematic properties or smectic properties may be exhibited. The temperature range in which the liquid crystal phase is exhibited is preferably room temperature (approximately 20° C. to 28° C.) to 300° C., and from the viewpoint of handleability and manufacturing suitability, more preferably 50° C. to 200° C.

In the present invention, from the viewpoint of tint adjustment, it is preferable to use at least one coloring agent compound (first dichroic azo coloring agent compound) having a maximal absorption wavelength in a wavelength range of 560 to 700 nm and at least one coloring agent compound (second dichroic azo coloring agent compound) having a maximal absorption wavelength in a wavelength range of 455 nm or more and less than 560 nm.

In the present invention, three or more kinds of dichroic azo coloring agent compounds may be used in combination. For example, from the viewpoint of making color of the light absorption anisotropic layer close to black, it is preferable to use the first dichroic azo coloring agent compound, the second dichroic azo coloring agent compound, and at least one coloring agent compound having a maximal absorption wavelength in a wavelength range of 380 nm or more and less than 455 nm (third dichroic azo coloring agent compound) in combination.

In the present invention, the dichroic azo coloring agent compound preferably has a crosslinkable group.

Examples of the crosslinkable group include cationically polymerizable groups such as an epoxy group, an epoxycyclohexyl group, and an oxetanyl group; and radically polymerizable groups such as an acryloyl group, a methacryloyl group, a vinyl group, a styryl group, and an allyl group.

The content of the dichroic substance contained in the light absorption anisotropic layer is not particularly limited, but from the viewpoint of increasing the alignment degree of the light absorption anisotropic layer to be formed, the content is preferably 3% by mass or more, more preferably 8% by mass or more, still more preferably 10% by mass or more, and particularly preferably 10% to 30% by mass with respect to the total mass of the light absorption anisotropic layer. In a case where a plurality of dichroic substances are used in combination, the total amount of the plurality of dichroic substances is preferably within the above range.

In addition, from the viewpoint of increasing the alignment degree of the light absorption anisotropic layer to be formed, the content of the dichroic substance contained in the light absorption anisotropic layer is preferably 20 to 650 mg/cm³, more preferably 25 to 500 mg/cm³, still more preferably 30 to 200 mg/cm³, and even still more preferably 40 to 150 mg/cm³. In a case where a plurality of dichroic substances are used in combination, the total amount of the plurality of dichroic substances is preferably within the above range.

Here, the content (mg/cm³) of the dichroic substance is obtained by measuring a solution in which a laminate including the light absorption anisotropic layer is dissolved, or an extraction liquid obtained by immersing the laminate in a solvent, using high performance liquid chromatography (HPLC); but the measurement method is not limited to the above-described method. In addition, the quantification can be performed by using the dichroic substance contained in the light absorption anisotropic layer as a standard sample.

Examples of the method of calculating the content of the dichroic substance include a method in which the volume is calculated by multiplying the thickness of the light absorption anisotropic layer obtained from a microscopic observation image of a cross section of the laminate by the area of the laminate used for measuring the coloring agent amount, and is divided by the coloring agent amount measured by HPLC to calculate the content of the coloring agent.

### <Liquid Crystal Compound>

The light absorption anisotropic layer contains a liquid crystal compound. In this manner, the dichroic substance can be aligned with a higher alignment degree while the precipitation of the dichroic substance is suppressed.

Both a polymer liquid crystal compound and a low-molecular-weight liquid crystal compound can be used as the liquid crystal compound, and a polymer liquid crystal compound is preferable from the viewpoint that the alignment degree can be increased. Further, a polymer liquid crystal compound and a low-molecular-weight liquid crystal compound may be used in combination as the liquid crystal compound.

Here, the “polymer liquid crystal compound” refers to a liquid crystal compound having a repeating unit in the chemical structure.

In addition, the “low-molecular-weight liquid crystal compound” refers to a liquid crystal compound having no repeating unit in the chemical structure.

Examples of the polymer liquid crystal compound include thermotropic liquid crystal polymers described in JP2011-237513A and polymer liquid crystal compounds described in paragraphs [0012] to [0042] of WO2018/199096A.

Examples of the low-molecular-weight liquid crystal compound include liquid crystal compounds described in paragraphs [0072] to [0088] of JP2013-228706A, and among these, a liquid crystal compound exhibiting smectic properties is preferable.

Examples of such a liquid crystal compound include compounds described in paragraphs [0019] to [0140] of WO2022/014340A, the description of which is incorporated herein by reference.

The content of the liquid crystal compound contained in the light absorption anisotropic layer is preferably 25 to 2,000 parts by mass, more preferably 100 to 1,300 parts by mass, and still more preferably 200 to 900 parts by mass with respect to 100 parts by mass of the content of the dichroic substance. In a case where the content of the liquid crystal compound is within the above-described range, the alignment degree of the dichroic substance is further improved.

The light absorption anisotropic layer may contain only one or two or more kinds of liquid crystal compounds. In a case where the light absorption anisotropic layer contains two or more kinds of liquid crystal compounds, the content of the liquid crystal compounds denotes the total content of the liquid crystal compounds.

### <Vertical Alignment Agent>

The light absorption anisotropic layer contains a vertical alignment agent.

Here, the vertical alignment agent refers to an additive having a function of aligning the above-described liquid crystal compound in a direction perpendicular to the main plane of the light absorption anisotropic layer. The term “aligning in a direction perpendicular to” does not require the alignment at exactly 90°, but means the alignment at 70° to 110°.

Examples of the vertical alignment agent include an ionic vertical alignment agent and a vertical alignment agent having a boronic acid group. From the reason that the transfer quality (characteristics in which elongation, tearing, wrinkles, folding, and the like do not occur) of the light absorption anisotropic layer is improved in a case where the laminate according to the embodiment of the present invention is bonded (transferred) to another member through the bonding layer of the laminate according to the embodiment of the present invention, it is preferable to use an ionic vertical alignment agent and a vertical alignment agent having a boronic acid group in combination.

Suitable examples of the ionic vertical alignment agent include an onium compound represented by Formula (B1).

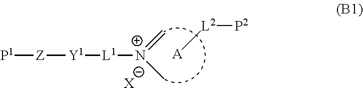

In Formula (B1), a ring A represents a quaternary ammonium ion consisting of a nitrogen-containing heterocyclic ring.

In addition, X represents an anion.

In addition, L¹ represents a divalent linking group.

In addition, L² represents a single bond or a divalent linking group.

In addition, Y¹ represents a divalent linking group having a 5-membered ring or a 6-membered ring as a partial structure.

In addition, Z represents a divalent linking group having an alkylene group having 2 to 20 carbon atoms as a partial structure.

In addition, P¹ and P² each independently represent a monovalent substituent having a polymerizable ethylenically unsaturated bond.

The ring A represents a quaternary ammonium ion consisting of a nitrogen-containing heterocyclic ring. Examples of the ring A include a pyridine ring, a picoline ring, a 2,2′-bipyridyl ring, a 4,4′-bipyridyl ring, a 1,10-phenanthroline ring, a quinoline ring, an oxazole ring, a thiazole ring, an imidazole ring, a pyrazine ring, a triazole ring, and a tetrazole ring, and the ring A is preferably a quaternary imidazolium ion or a quaternary pyridinium ion.

X represents an anion. Examples of X include a halogen anion (for example, a fluorine ion, a chlorine ion, a bromine ion, an iodine ion, and the like), a sulfonate ion (for example, a methanesulfonate ion, a trifluoromethanesulfonate ion, a methylsulfate ion, a vinylsulfonate ion, an allylsulfonate ion, a p-toluenesulfonate ion, a p-chlorobenzenesulfonate ion, a p-vinylbenzenesulfonate ion, a 1,3-benzenedisulfonate ion, a 1,5-naphthalenedisulfonate ion, a 2,6-naphthalenedisulfonate ion, and the like), a sulfate ion, a carbonate ion, a nitrate ion, a thiocyanate ion, a perchlorate ion, a tetrafluoroborate ion, a picrate ion, an acetate ion, a benzoate ion, a p-vinyl benzoate ion, a formate ion, a trifluoroacetate ion, a phosphate ion (for example, hexafluorophosphate ion), and a hydroxide ion. X is preferably a halogen anion, a sulfonate ion, or a hydroxide ion. In addition, a chlorine ion, a bromine ion, an iodine ion, a methanesulfonate ion, a vinylsulfonate ion, a p-toluenesulfonate ion, or a p-vinylbenzenesulfonate ion is particularly preferable.

L¹ represents a divalent linking group. Examples of L¹ include a divalent linking group having 1 to 20 carbon atoms, consisting of a combination of an alkylene group, —O—, —S—, —CO—, —SO₂—, —NRa- (here, Ra is an alkyl group having 1 to 5 carbon atoms or a hydrogen atom), an alkenylene group, an alkynylene group, and an arylene group. L¹ is preferably -AL-, —O-AL-, —CO—O-AL-, or —O—CO-AL-, each of which has 1 to 10 carbon atoms, more preferably -AL- or —O-AL-, each of which has 1 to 10 carbon atoms, and most preferably -AL- or —O-AL-, each of which has 1 to 5 carbon atoms. AL represents an alkylene group.

L² represents a single bond or a divalent linking group. Examples of L² include a divalent linking group having 1 to 10 carbon atoms, consisting of a combination of an alkylene group, —O—, —S—, —CO—, —SO₂—, —NRa- (here, Ra is an alkyl group having 1 to 5 carbon atoms or a hydrogen atom), an alkenylene group, an alkynylene group, and an arylene group; a single bond, —O—, —O—CO—, —CO—O—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO—, and —O—CO-AL-CO—O—. AL represents an alkylene group. L² is preferably a single bond, -AL-, —O-AL-, or —NRa-AL-O—, each of which has 1 to 10 carbon atoms, more preferably a single bond, -AL-, —O-AL-, or —NRa-AL-O—, each of which has 1 to 5 carbon atoms, and most preferably a single bond, —O-AL-, or —NRa-AL-O—, each of which has 1 to 5 carbon atoms.

Y¹ represents a divalent linking group having a 5- or 6-membered ring as a partial structure. Examples of Y¹ include a cyclohexyl ring, an aromatic ring, or a heterocyclic ring. Examples of the aromatic ring include a benzene ring, an indene ring, a naphthalene ring, a fluorene ring, a phenanthrene ring, an anthracene ring, a biphenyl ring, and a pyrene ring, and a benzene ring, a biphenyl ring, or a naphthalene ring is particularly preferable. As a heteroatom constituting the heterocyclic ring, a nitrogen atom, an oxygen atom, or a sulfur atom is preferable, and examples of the heterocyclic ring include a furan ring, a thiophene ring, a pyrrole ring, a pyrroline ring, a pyrrolidine ring, an oxazole ring, an isoxazole ring, a thiazole ring, an isothiazole ring, an imidazole ring, an imidazoline ring, an imidazolidine ring, a pyrazole ring, a pyrazoline ring, a pyrazolidine ring, a triazole ring, a furazan ring, a tetrazole ring, a pyran ring, a dioxane ring, a dithiane ring, a thin ring, a pyridine ring, a piperidine ring, an oxazine ring, a morpholine ring, a thiazine ring, a pyridazine ring, a pyrimidine ring, a pyrazine ring, a piperazine ring, and a triazine ring. The heterocyclic ring is preferably a 6-membered ring. The divalent linking group represented by Y¹, having a 5- or 6-membered ring as a partial structure, may further have a substituent (for example, the above-described substituent W).

The divalent linking group represented by Y¹ is preferably a divalent linking group having two or more 5- or 6-membered rings, and more preferably has a structure in which two or more rings are linked to each other through a linking group. Examples of the linking group include the examples of the linking group represented by L¹ and L², —C≡C—, —CH═CH—, —CH═N—, —N═CH—, and —N═N—.

Z represents a divalent linking group which has an alkylene group having 2 to 20 carbon atoms as a partial structure and consists of a combination of —O—, —S—, —CO—, and —SO₂—, in which the alkylene group may have a substituent. Examples of the above-described divalent linking group include an alkyleneoxy group and a polyalkyleneoxy group. The number of carbon atoms in the alkylene group represented by Z is more preferably 2 to 16, still more preferably 2 to 12, and particularly preferably 2 to 8.

P1 and P2 each independently represent a monovalent substituent having a polymerizable ethylenically unsaturated group. Examples of the above-described monovalent substituent having a polymerizable ethylenically unsaturated group include Formulae (M-1) to (M-8). That is, the monovalent substituent having a polymerizable ethylenically unsaturated group may be a substituent consisting of only an ethenyl group as in Formula (M-8).

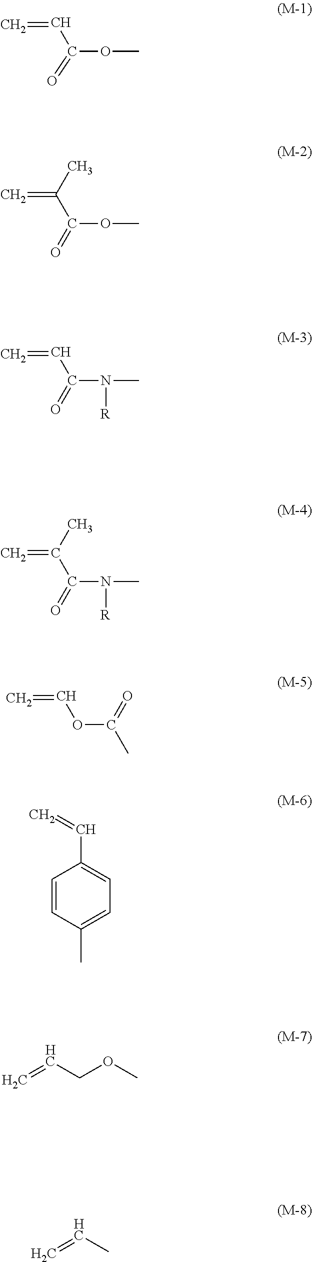

In Formulae (M-3) and (M-4), R represents a hydrogen atom or an alkyl group, and a hydrogen atom or a methyl group is preferable. Among Formulae (M-1) to (M-8), (M-1), (M-2), or (M-8) is preferable, and (M-1) or (M-8) is more preferable. In particular, P1 is preferably (M-1). In addition, P2 is preferably (M-1) or (M-8), and in a compound in which the ring A is quaternary imidazolium ion, P2 is preferably (M-8) or (M-1), and in a compound in which the ring A is a quaternary pyridinium ion, P2 is preferably (M-1).

Examples of the onium compound represented by Formula (B1) include onium salts described in paragraphs 0052 to 0058 of JP2012-208397A, onium salts described in paragraphs 0024 to 0055 of JP2008-026730A, and onium salts described in JP2002-37777A.

Examples of the ionic vertical alignment agent include those described in paragraphs [0017] to [0029] of JP2020-181150A, in addition to the onium compound represented by Formula (B1).

Suitable examples of the vertical alignment agent having a boronic acid group include a boronic acid compound represented by Formula (B2).

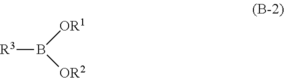

In Formula (B2), R¹ and R² each independently represent a hydrogen atom, an aliphatic hydrocarbon group which may have a substituent, an aryl group which may have a substituent, or a heterocyclic group which may have a substituent.

In addition, R³ represents a substituent.

Examples of the aliphatic hydrocarbon group represented by one aspect of R¹ and R² include a linear or branched alkyl group having 1 to 20 carbon atoms, which may be substituted or unsubstituted, (for example, a methyl group, an ethyl group, an iso-propyl group, and the like), a substituted or unsubstituted cyclic alkyl group having 3 to 20 carbon atoms (for example, a cyclohexyl group and the like), and an alkenyl group having 2 to 20 carbon atoms (for example, a vinyl group and the like).

In addition, examples of the aryl group represented by one aspect of R¹ and R² include a substituted or unsubstituted phenyl group having 6 to 20 carbon atoms (for example, a phenyl group, a tolyl group, and the like), and a substituted or unsubstituted naphthyl group having 10 to 20 carbon atoms.

In addition, examples of the heterocyclic group represented by one aspect of R¹ and R² include a substituted or unsubstituted 5-membered or 6-membered ring group including at least one heteroatom (for example, a nitrogen atom, an oxygen atom, a sulfur atom, and the like), and specific examples thereof include a pyridyl group, an imidazolyl group, a furyl group, a piperidyl group, and a morpholino group.

R¹ and R² may be linked to each other to form a ring. For example, isopropyl groups of R¹ and R² may be linked to each other to form a 4,4,5,5-tetramethyl-1,3,2-dioxaborolane ring.

As R¹ and R², a hydrogen atom, a linear or branched alkyl group having 1 to 3 carbon atoms, or an aspect in which these groups are linked to each other to form a ring is preferable, and a hydrogen atom is more preferable.

As the substituent represented by R³, a substituent including a functional group which can be bonded to a (meth)acrylic group is preferable.

Here, examples of the functional group which can be bonded to a (meth)acrylic group include a vinyl group, an acrylate group, a methacrylate group, an acrylamide group, a styryl group, a vinyl ketone group, a butadiene group, a vinyl ether group, an oxiranyl group, an aziridinyl group, and an oxetane group. Among these, a vinyl group, an acrylate group, a methacrylate group, a styryl group, an oxiranyl group, or an oxetane group is preferable, and a vinyl group, an acrylate group, an acrylamide group, or a styryl group is more preferable.

R³ is preferably a substituted or unsubstituted aliphatic hydrocarbon group, aryl group, or heterocyclic group having the functional group which can be bonded to a (meth)acrylic group.

Examples of the aliphatic hydrocarbon group include a substituted or unsubstituted linear or branched alkyl group having 1 to 30 carbon atoms (for example, a methyl group, an ethyl group, an iso-propyl group, an n-propyl group, a butyl group, a pentyl group, a hexyl group, a heptyl group, an octyl group, a nonyl group, a decyl group, an undecyl group, a dodecyl group, a tridecyl group, a hexadecyl group, an octadecyl group, an eicosyl group, an isopropyl group, an isobutyl group, an sec-butyl group, a tert-butyl group, an isopentyl group, a neopentyl group, a 1-methylbutyl group, an isohexyl group, a 2-methylhexyl group, and the like), a substituted or unsubstituted cyclic alkyl group having 3 to 20 carbon atoms (for example, a cyclopentyl group, a cyclohexyl group, a 1-adamantyl group, a 2-norbornyl group, and the like), and an alkenyl group having 2 to 20 carbon atoms (for example, a vinyl group, a 1-propenyl group, a 1-butenyl group, a 1-methyl-1-propenyl group, and the like).

Examples of the aryl group include a substituted or unsubstituted phenyl group having 6 to 50 carbon atoms (for example, a phenyl group, a tolyl group, a styryl group, a 4-benzoyloxyphenyl group, a 4-phenoxycarbonylphenyl group, a 4-biphenyl group, a 4-(4-octyloxybenzoyloxy)phenoxycarbonylphenyl group, and the like), and a substituted or unsubstituted naphthyl group having 10 to 50 carbon atoms (for example, an unsubstituted naphthyl group and the like).

The heterocyclic group is, for example, a substituted or unsubstituted 5-membered or 6-membered ring group including at least one heteroatom (for example, a nitrogen atom, an oxygen atom, a sulfur atom, and the like), and examples thereof include groups of pyrrole, furan, thiophene, pyrazole, imidazole, triazole, oxazole, isoxazole, oxadiazole, thiazole, thiadiazole, indole, carbazole, benzofuran, dibenzofuran, thianaphthene, dibenzothiophene, indazole, benzimidazole, anthranil, benzisoxazole, benzoxazole, benzothiazole, purine, pyridine, pyridazine, pyrimidine, pyrazine, triazine, quinoline, acridine, isoquinoline, phthalazine, quinazoline, quinoxaline, naphthyridine, phenanthroline, pteridine, morpholine, and piperidine, and the like.

Examples of the boronic acid compound represented by Formula (B2) include a boronic acid compound represented by General Formula (I) described in paragraphs 0023 to 0032 of JP2008-225281A.

As the compound represented by Formula (B2), compounds exemplified below are also preferable.

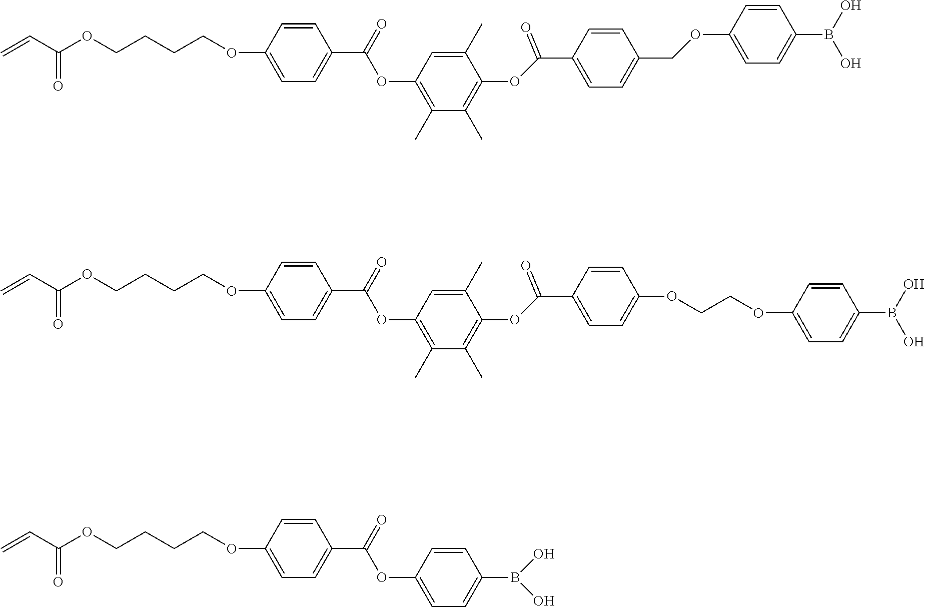 [SMILES: C=CC(=O)OCCCCOc1ccc(C(=O)Oc2cc(C)c(OC(=O)c3ccc(COc4ccc(B(O)O)cc4)cc3)c(C)c2C)cc1 ; C=CC(=O)OCCCCOc1ccc(C(=O)Oc2cc(C)c(OC(=O)c3ccc(OCCOc4ccc(B(O)O)cc4)cc3)c(C)c2C)cc1 ; C=CC(=O)OCCCCOc1ccc(C(=O)Oc2ccc(B(O)O)cc2)cc1]

The content of the vertical alignment agent contained in the light absorption anisotropic layer is preferably 1.0 to 7.0 parts by mass, more preferably 1.5 to 8.0 parts by mass, and still more preferably 2.5 to 6.0 parts by mass with respect to 100 parts by mass of the content of the liquid crystal compound.

The liquid crystal composition may include only one kind of the vertical alignment agent, or may include two or more kinds thereof. In a case where the liquid crystal composition contains two or more kinds of liquid crystal compounds, the content of the vertical alignment agent means the total content of the vertical alignment agents.

In the present invention, the light absorption anisotropic layer is preferably a layer formed by fixing an alignment state of a liquid crystal composition containing the above-described dichroic substance, liquid crystal compound, and vertical alignment agent, and from the viewpoint of improving the transfer quality of the light absorption anisotropic layer, it is more preferably a layer formed by fixing an alignment state of a liquid crystal composition containing the above-described dichroic substance, liquid crystal compound, and vertical alignment agent, and an additive having a crosslinkable group (hereinafter, also referred to as a “crosslinkable group-containing additive”) which does not correspond to these components. In addition, the dichroic substance contained in the liquid crystal composition is preferably a dichroic substance having a polymerizable group and more preferably a dichroic substance having a radically polymerizable group among the above-described dichroic substances.

### <Crosslinkable Group-Containing Additive>

Examples of the crosslinkable group contained in the crosslinkable group-containing additive include a radically polymerizable group and an active hydrogen reactive group, and among these, an active hydrogen reactive group is preferable.

Here, the “active hydrogen reactive group” means a group reactive to a group (active hydrogen group) having active hydrogen, such as a carboxyl group (—COOH), a hydroxyl group (—OH), and an amino group (—NH₂).

Examples of such an active hydrogen reactive group include an epoxy group, a glycidyl group, an isocyanate group, a thioisocyanate group, an alkoxysilyl group, an oxazoline group, a carbodiimide group, an aziridine group, an imide group, and a maleic anhydride group. These active hydrogen reactive groups may be used alone or in combination of two or more kinds thereof.

Among these, an epoxy group or a glycidyl group is preferable since the flexibility of the laminate is further improved, the transfer quality of the light absorption anisotropic layer is also improved, and safety is excellent.

Examples of the compound containing an epoxy group or a glycidyl group include bisphenol types such as bisphenol A type, bisphenol F type, bisphenol S type, and hydrogenated types thereof, novolak types such as phenol novolak type and cresol novolak type, nitrogen-containing cyclic types such as triglycidyl isocyanurate type and hydantoin type, alicyclic type, aliphatic type, aromatic types such as naphthalene type, glycidyl ether type, low water absorption types such as biphenyl type, dicyclo type, ester type, ether ester type, and modified types thereof.

In the present invention, from the viewpoint of improving the transfer quality of the light absorption anisotropic layer, it is preferable that the compound is a compound having an active hydrogen reactive group contained in the crosslinkable group-containing additive, and the above-described vertical alignment agent is an ionic vertical alignment agent.

Here, the reason why the transfer quality of the light absorption anisotropic layer is improved is not clear, but it is considered that the intermediate (particularly, the intermediate cation) generated in a case where the crosslinkable group-containing additive is crosslinked is stabilized in the presence of the ionic vertical alignment agent, and thus the crosslinking efficiency is improved.

The content of the crosslinkable group-containing additive contained in the light absorption anisotropic layer is preferably 3.0 to 20.0 parts by mass, more preferably 5.0 to 16.0 parts by mass, and still more preferably 8.0 to 12.0 parts by mass with respect to 100 parts by mass of the content of the liquid crystal compound.

The crosslinkable group-containing additive may be contained alone or in combination of two or more kinds thereof. In a case where the liquid crystal compound includes two or more kinds of liquid crystal compounds, the content of the crosslinkable group-containing additive means the total content of the crosslinkable group-containing additives.

### <Solvent>

From the viewpoint of workability and the like, it is preferable that the liquid crystal composition contains a solvent.

Examples of the solvent include organic solvents such as ketones (such as acetone, 2-butanone, methyl isobutyl ketone, cyclopentanone, cyclohexanone, and acetylacetone), ethers (such as dioxane, tetrahydrofuran, tetrahydropyran, dioxolane, tetrahydrofurfuryl alcohol, cyclopentyl methyl ether, and dibutyl ether), aliphatic hydrocarbons (such as hexane), alicyclic hydrocarbons (such as cyclohexane), aromatic hydrocarbons (such as benzene, toluene, xylene, tetralin, and trimethylbenzene), halogenated carbons (such as dichloromethane, trichloromethane (chloroform), dichloroethane, dichlorobenzene, 1,1,2,2-tetrachloroethane, and chlorotoluene), esters (such as methyl acetate, ethyl acetate, butyl acetate, diethyl carbonate, ethyl acetoacetate, n-pentyl acetate, ethyl benzoate, benzyl benzoate, butyl carbitol acetate, diethylene glycol monoethyl ether acetate, and isoamyl acetate), alcohols (such as ethanol, isopropanol, butanol, cyclohexanol, furfuryl alcohol, 2-ethylhexanol, octanol, benzyl alcohol, ethanolamine, ethylene glycol, propylene glycol, diethylene glycol, diethylene glycol monomethyl ether, diethylene glycol monoethyl ether, and diethylene glycol monobutyl ether), phenols (such as phenol and cresol), cellosolves (such as methyl cellosolve, ethyl cellosolve, and 1,2-dimethoxyethane), cellosolve acetates, sulfoxides (such as dimethyl sulfoxide), amides (such as dimethylformamide, dimethylacetamide, N-methylpyrrolidone, N-ethylpyrrolidone, and 1,3-dimethyl-2-imidazolidinone), and heterocyclic compounds (such as pyridine and 2,6-lutidine); and water.

These solvents may be used alone or in combination of two or more kinds thereof.

In a case where the liquid crystal composition contains a solvent, a content of the solvent is preferably 60% to 99.5% by mass, more preferably 70% to 99% by mass, and particularly preferably 75% to 98% by mass with respect to the total mass (100% by mass) of the liquid crystal composition.

### <Polymerization Initiator>

The liquid crystal composition may contain a polymerization initiator.

The polymerization initiator is not particularly limited, but a compound having photosensitivity, that is, a photopolymerization initiator is preferable.

As the photopolymerization initiator, various compounds can be used without any particular limitation. Examples of the photopolymerization initiator include α-carbonyl compounds (U.S. Pat. Nos. 2,367,661A and 2,367,670A), acyloin ether (U.S. Pat. No. 2,448,828A), α-hydrocarbon-substituted aromatic acyloin compounds (U.S. Pat. No. 2,722,512A), polynuclear quinone compounds (U.S. Pat. Nos. 3,046,127A and 2,951,758A), a combination of a triarylimidazole dimer and a p-aminophenyl ketone (U.S. Pat. No. 3,549,367A), acridine and phenazine compounds (JP1985-105667A (JP-S60-105667A) and U.S. Pat. No. 4,239,850A), oxadiazole compounds (U.S. Pat. No. 4,212,970A), o-acyloxime compounds ([0065] of JP2016-27384A), and acylphosphine oxide compounds (JP1988-40799B (JP-S63-40799B), JP1993-29234B (JP-H5-29234B), JP1998-95788A (JP-H10-95788A), and JP1998-29997A (JP-H10-29997A)).

Commercially available products can also be used as such a photopolymerization initiator, and examples thereof include IRGACURE-184, IRGACURE-907, IRGACURE-369, IRGACURE-651, IRGACURE-819, IRGACURE-OXE-01, and IRGACURE-OXE-02, manufactured by BASF SE.

In a case where the liquid crystal composition contains a polymerization initiator, a content of the polymerization initiator is preferably 0.01% to 30% by mass and more preferably 0.1% to 15% by mass with respect to the total solid content mass of the liquid crystal composition.

### [Polymerizable Compound]

The liquid crystal composition may contain a polymerizable compound.

Examples of the polymerizable compound include a compound including an acrylate (such as a (meth)acrylate monomer).

In a case where the liquid crystal composition contains a polymerizable compound, a content of the polymerizable compound is preferably 0.5% to 50% by mass and more preferably 1.0% to 40% by mass with respect to the total solid content mass of the liquid crystal composition.

### <Interface Improver>

The liquid crystal composition may contain an interface improver.

The interface improver is not particularly limited, and a polymer-based interface improver or a low-molecular-weight interface improver can be used, and compounds described in paragraphs [0253] to [0293] of JP2011-237513A can also be used.

In addition, fluorine (meth)acrylate-based polymers described in paragraphs [0018] to [0043] of JP2007-272185A can also be used as the interface improver.

In addition, examples of the interface improver include compound described in paragraphs [0079] to [0102] of JP2007-069471A, polymerizable liquid crystal compounds represented by Formula (4) described in JP2013-047204A (particularly, compounds described in paragraphs [0020] to [0032]), polymerizable liquid crystal compounds represented by Formula (4) described in JP2012-211306A (particularly, compounds described in paragraphs [0022] to [0029]), liquid crystal alignment promoters represented by Formula (4) described in JP2002-129162A (particularly, compounds described in paragraphs [0076] to [0078] and paragraphs [0082] to [0084]), compounds represented by Formulae (4), (II), and (III) described in JP2005-099248A (particularly, compounds described in paragraphs [0092] to [0096]), compounds described in paragraphs [0013] to [0059] of JP4385997B, compounds described in paragraphs [0018] to [0044] of JP5034200B, and compounds described in paragraphs [0019] to [0038] of JP4895088B.

Furthermore, a silicon-based polymer can also be used as the interface improver.

The interface improvers may be used alone or in combination of two or more kinds thereof.

In a case where the liquid crystal composition contains an interface improver, a content of the interface improver is preferably 0.005% to 15% by mass, more preferably 0.01% to 5% by mass, and still more preferably 0.015% to 3% by mass with respect to the total solid content mass of the liquid crystal composition. In a case where a plurality of interface improvers are used in combination, it is preferable that the total amount of the plurality of interface improvers is within the above-described range.

### <Method of Forming Light Absorption Anisotropic Layer>

A method of forming the light absorption anisotropic layer is not particularly limited, and examples thereof include a method including, in the following order, a step of applying the above-described liquid crystal composition (hereinafter, also referred to as “composition for forming a light absorption anisotropic layer”) to form a coating film (hereinafter, also referred to as “coating film forming step”) and a step of aligning a liquid crystalline component or a dichroic substance contained in the coating film (hereinafter, also referred to as “alignment step”).

In a case where the above-described dichroic substance has liquid crystallinity, the liquid crystalline component is a component which also includes the dichroic substance having liquid crystallinity in addition to the above-described liquid crystal compound.

### (Coating Film Forming Step)

The coating film forming step is a step of applying the composition for forming a light absorption anisotropic layer to form a coating film.

The composition for forming a light absorption anisotropic layer can be easily applied by using a composition for forming a light absorption anisotropic layer, which contains the above-described solvent, or using a liquid such as a melt obtained by heating the composition for forming a light absorption anisotropic layer.

Specific examples of the method of applying the composition for forming a light absorption anisotropic layer include known methods such as a roll coating method, a gravure printing method, a spin coating method, a wire bar coating method, an extrusion coating method, a direct gravure coating method, a reverse gravure coating method, a die-coating method, a spraying method, and an ink jet method.

In the present invention, from the viewpoint of increasing the optical effect (for example, viewing angle control), the coating amount of the dichroic substance in the coating film forming step is preferably 15 mg/m² or more, more preferably 50 to 1,000 mg/m², and still more preferably 200 to 800 mg/m².

### (Alignment Step)

The aligning step is a step of aligning the liquid crystal component contained in the coating film. In this manner, the light absorption anisotropic layer is obtained.

The alignment step may include a drying treatment. Components such as a solvent can be removed from the coating film by performing the drying treatment. The drying treatment may be performed by a method of allowing the coating film to stand at room temperature for a predetermined time (for example, natural drying) or a method of heating the coating film and/or blowing air to the coating film.

Here, the liquid crystalline component contained in the composition for forming a light absorption anisotropic layer may be aligned by the coating film forming step or the drying treatment described above. For example, in an aspect in which the composition for forming a light absorption anisotropic layer is prepared as a coating liquid containing a solvent, a coating film having light absorption anisotropy (that is, a light absorption anisotropic layer) is obtained by drying the coating film and removing the solvent from the coating film.

In a case where the drying treatment is performed at a temperature higher than or equal to a transition temperature of the liquid crystalline component contained in the coating film to the liquid crystal phase, a heat treatment described below may not be performed.

From the viewpoint of manufacturing suitability or the like, the transition temperature of the liquid crystalline component contained in the coating film to the liquid crystal phase is preferably 10° C. to 250° C. and more preferably 25° C. to 190° C. In a case where the above-described transition temperature is 10° C. or higher, a cooling treatment or the like for lowering the temperature to a temperature range in which the liquid crystal phase is exhibited is not necessary, which is preferable. In addition, in a case where the above-described transition temperature is 250° C. or lower, a high temperature is not required even in a case of setting an isotropic liquid state at a temperature higher than the temperature range in which the liquid crystal phase is temporarily exhibited, and waste of thermal energy and deformation and deterioration of a substrate can be reduced, which is preferable.

The aligning step preferably has a heating treatment. In this manner, since the liquid crystalline component contained in the coating film can be aligned, the coating film after being subjected to the heat treatment can be suitably used as the light absorption anisotropic layer.

From the viewpoint of the manufacturing suitability or the like, the heat treatment is performed at a temperature of preferably 10° C. to 250° C. and more preferably 25° C. to 190° C. Further, the heating time is preferably 1 to 300 seconds, and more preferably 1 to 60 seconds.

The aligning step may have a cooling treatment to be performed after the heating treatment. The cooling treatment is a treatment of cooling the heated coating film to room temperature (20° C. to 25° C.). In this manner, the alignment of the liquid crystalline component contained in the coating film can be fixed. A cooling unit is not particularly limited, and the cooling treatment can be performed according to a known method.

The light absorption anisotropic layer can be obtained by performing the above-described steps.

In the present embodiment, examples of a method of aligning the liquid crystalline component contained in the coating film include the drying treatment and the heat treatment, but the present invention is not limited thereto, and the liquid crystalline component can be aligned by a known alignment treatment.

### <Other Steps>

The method of forming the light absorption anisotropic layer may include a step of curing the light absorption anisotropic layer after the alignment step (hereinafter, also referred to as “curing step”).

The curing step is performed by heating the light absorption anisotropic layer and/or irradiating the light absorption anisotropic layer with light (exposing the light absorption anisotropic layer to light), for example, in a case where the light absorption anisotropic layer has a crosslinkable group (polymerizable group). Among these, it is preferable that the curing step is performed by irradiating the light absorption anisotropic layer with light.

Various light sources such as infrared rays, visible light, and ultraviolet rays can be used as the light source for curing, but ultraviolet rays are preferable. In addition, ultraviolet rays may be applied while the layer is heated during curing, or ultraviolet rays may be applied through a filter which transmits only a specific wavelength.

In a case where the exposure is performed while the layer is heated, the heating temperature during the exposure depends on the transition temperature of the liquid crystalline component contained in the liquid crystal film to the liquid crystal phase, but it is preferably 25° C. to 140° C.

In addition, the exposure may be performed under a nitrogen atmosphere. In a case where the curing of the liquid crystal film proceeds by radical polymerization, since inhibition of polymerization by oxygen is reduced, it is preferable that the exposure is performed in a nitrogen atmosphere.

In the present invention, the thickness of the light absorption anisotropic layer is not particularly limited, but from the reason that the light shielding properties in an oblique direction can be improved and the alignment degree of the light absorption anisotropic layer is increased, the thickness is preferably 1.5 μm or more, more preferably 2 to 10 μm, and still more preferably 2 to 8 μm.

Here, the thickness of the light absorption anisotropic layer is measured by cutting the light absorption anisotropic layer using a microtome to prepare a sample having a cross section, observing the cross section with a scanning electron microscope from a normal direction with respect to the cross section, and measuring the thickness.

In the present invention, in a case of being applied to an image display device, from the viewpoint of suppressing tinting of a display screen, a difference in the alignment degree of the light absorption anisotropic layer at a wavelength of 450 nm, 550 nm, and 650 nm is preferably 0.025 or less, more preferably 0.020 or less, and still more preferably 0.010 or less.

Here, as the alignment degree of the light absorption anisotropic layer at wavelengths of 450 nm, 550 nm, and 650 nm, values calculated by the following method are adopted.

Specifically, the Mueller matrix is measured at polar angles in a range of −70° to 70° at intervals of 5° in the in-plane slow axis direction using AxoScan (manufactured by Axometrics, Inc.), and kx(λ), ky(λ), and kz(λ) are obtained by fitting.

Next, the absorption anisotropies Ao(λ) and Ae(λ) are obtained according to the following equations (A) to (D), and the alignment degree S is calculated according to the following equation (E).

$$To ( λ ) = EXP \{ - 4 \times π \times ( kx ( λ ) + ky ( λ ) ) / 2 \times d / λ \} \qquad ( A )$$

$$Te ( λ ) = EXP \{ - 4 \times π \times kz ( λ ) \times d / λ \} \qquad ( B )$$

$$Ao ( λ ) = - log ( To ( λ ) ) \qquad ( C )$$

$$Ae ( λ ) = - log ( Te ( λ ) ) \qquad ( D )$$

$$Alignment degree S ( λ ) = [ Ao ( λ ) / Ae ( λ ) - 1 ] / [ Ao ( λ ) / Ae ( λ ) + 2 ] \qquad ( E )$$

Here, d represents a film thickness (nm) of the light absorption anisotropic layer, To(λ) and Te(λ) represent transmittance, and Ao(λ) and Ae(λ) represent absorbance.

The difference in the alignment degrees (0.025 or less) defined in Requirement 3 described above refers to the maximum difference among the difference in the alignment degrees at each of the wavelengths of 450 nm and 550 nm, the difference in the alignment degrees at each of the wavelengths of 450 nm and 650 nm, and the difference in the alignment degrees at each of the wavelengths of 550 nm and 650 nm.

In addition, in the present invention, from the viewpoint of absorbing a larger amount of polarized light incident from a specific direction into the light absorption anisotropic layer and obtaining preferable optical performance, the alignment degree of the light absorption anisotropic layer at a wavelength of 550 nm is preferably 0.90 or more, more preferably 0.93 to 1.00, and still more preferably 0.96 to 1.00.

Here, the alignment degree of the light absorption anisotropic layer at a wavelength of 550 nm can be calculated by the above-described method.

In addition, from the viewpoint of easily making a difference in the alignment degree of the light absorption anisotropic layer at a wavelength of 450 nm, 550 nm, and 650 nm to be 0.025 or less, it is preferable to perform the heating treatment in the above-described alignment step a plurality of times (particularly, twice).

In addition, the cooling treatment performed between the two heating treatments is preferably a treatment of cooling the coating film after the first heating treatment to approximately 30° C. to 45° C.

In the present invention, from the viewpoint of maintaining a high degree of polarization of light passing through the light absorption anisotropic layer and further improving optical performance, the haze value of the light absorption anisotropic layer is preferably 0.3% or less, more preferably 0.2% or less, and still more preferably 0.1% or less.

Here, the haze value refers to haze measured in accordance with “Method of Obtaining Haze of Plastic—Transparent Materials” of JIS K7136:2000, and refers to a value measured with a haze meter (for example, NDH2000 (manufactured by Nippon Denshoku Industries Co., Ltd.)) in an environment of 25° C. and a relative humidity of 55%.

In addition, from the viewpoint of easily setting the haze value of the light absorption anisotropic layer to 0.3% or less, it is preferable to perform the heating treatment in the alignment step described above a plurality of times (particularly, twice). In particular, it is preferable to lower the temperature in the two heating treatments, and specifically, the temperature is more preferably 65° C. to 80° C.

### [Alignment Film]

The alignment film of the laminate according to the embodiment of the present invention may be any film as long as the film can vertically align the liquid crystal compound contained in the light absorption anisotropic layer.

Examples of the method for forming an alignment film include methods such as rubbing treatment of a film surface of an organic compound (preferably a polymer), oblique vapor deposition of an inorganic compound, formation of a layer having microgrooves, and accumulation of an organic compound (for example, ω-tricosanoic acid, dioctadecylmethylammonium chloride, or methyl stearate) by the Langmuir-Blodgett method (LB film). Furthermore, an alignment film in which an alignment function is generated by application of an electric field, application of a magnetic field, or irradiation with light has also been known.

Among these, in the present invention, an alignment film formed by performing a rubbing treatment is preferable from the viewpoint of easily controlling the pretilt angle of the alignment film, and a photo-alignment film formed by irradiation with light is also preferable from the viewpoint of the uniformity of alignment.

### <Rubbing-Treated Alignment Film>

A polymer material used for the alignment film formed by performing a rubbing treatment is described in a plurality of documents, and a plurality of commercially available products can be used. In the present invention, polyvinyl alcohol or polyimide and derivatives thereof are preferably used. The alignment film can refer to the description on page 43, line 24 to page 49, line 8 of WO2001/88574A1. A thickness of the alignment film is preferably 0.01 to 10 μm and more preferably 0.01 to 2 μm.

### <Photo-Alignment Film>

A photo-alignment compound used for the alignment film formed by irradiation with light is described in a plurality of documents. In the present invention, preferred examples thereof include azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B, aromatic ester compounds described in JP2002-229039A, maleimide and/or alkenyl-substituted nadiimide compounds having a photo-alignment unit described in JP2002-265541A and JP2002-317013A, photocrosslinkable silane derivatives described in JP4205195B and JP4205198B, and photocrosslinkable polyimides, polyamides, or esters described in JP2003-520878A, JP2004-529220A, and JP4162850B. Azo compounds, photo-crosslinkable polyimides, polyamides, or esters are more preferable.

Among these, a photosensitive compound having a photo-aligned group, which undergoes at least one of dimerization or isomerization by action of light is preferably used as the photo-alignment compound.

In addition, examples of the photo-aligned group include a group having a cinnamic acid (cinnamoyl) structure (skeleton), a group having a coumarin structure (skeleton), a group having a chalcone structure (skeleton), a group having a benzophenone structure (skeleton), and a group having an anthracene structure (skeleton). Among these groups, a group having a cinnamoyl structure or a group having a coumarin structure is preferable, and a group having a cinnamoyl structure is more preferable.

In addition, the photosensitive compound having the above-described photo-aligned group may further have a crosslinkable group.

As the crosslinkable group, a thermally crosslinkable group which causes a curing reaction due to the action of heat and a photocrosslinkable group which causes a curing reaction due to the action of light are preferable, and the crosslinkable group may be a crosslinkable group which contains both a thermally crosslinkable group and a photocrosslinkable group.

Examples of the above-described crosslinkable group include at least one selected from the group consisting of an epoxy group, an oxetanyl group, a group represented by —NH—CH₂—O—R (R represents a hydrogen atom or an alkyl group having 1 to 20 carbon atoms), a group having an ethylenically unsaturated double bond, and a blocked isocyanate group. Among these, an epoxy group, an oxetanyl group, or a group having an ethylenically unsaturated double bond is preferable.

A 3-membered cyclic ether group is also referred to as the epoxy group, and a 4-membered cyclic ether group is also referred to as the oxetanyl group.

In addition, specific examples of the group having an ethylenically unsaturated double bond include a vinyl group, an allyl group, a styryl group, an acryloyl group, and a methacryloyl group, and an acryloyl group or a methacryloyl group is preferable.

The photo-alignment film formed of the above-described material is irradiated with linearly polarized light or non-polarized light to manufacture a photo-alignment film.

In the present specification, the “irradiation with linearly polarized light” and the “irradiation with non-polarized light” are operations for causing a photo-reaction in the photo-alignment material. A wavelength of the light to be used varies depending on the photo-alignment material to be used, and is not particularly limited as long as the wavelength is required for the photo-reaction. A peak wavelength of the light to be used for irradiation with light is preferably 200 nm to 700 nm, and ultraviolet light having a peak wavelength of 400 nm or less is more preferable.

Examples of a light source used for the light irradiation include commonly used light sources, for example, lamps such as a tungsten lamp, a halogen lamp, a xenon lamp, a xenon flash lamp, a mercury lamp, a mercury xenon lamp, or a carbon arc lamp, various lasers [such as a semiconductor laser, a helium neon laser, an argon ion laser, a helium cadmium laser, and a yttrium aluminum garnet (YAG) laser], a light emitting diode, and a cathode ray tube.

As a method of obtaining the linearly polarized light, a method of using a polarizing plate (for example, iodine polarizing plate, dichroic coloring agent polarizing plate, and wire grid polarizing plate), a method of using a prismatic element (for example, Glan-Thomson prism) or a reflective type polarizer using Brewster's angle, or a method of using light emitted from a polarized laser light source can be adopted. In addition, by using a filter, a wavelength conversion element, or the like, only light having a required wavelength may be radiated selectively.

In a case where light to be applied is the linearly polarized light, a method of applying light vertically or obliquely to the upper surface of the alignment film or the surface of the alignment film from the rear surface is employed. An incidence angle of light varies depending on the photo-alignment material, but is preferably 0° to 90° (vertical) and more preferably 40° to 90°.

In a case where the light to be applied is the non-polarized light, the alignment film is irradiated with the non-polarized light obliquely. An incidence angle is preferably 10° to 80°, more preferably 20° to 60°, and particularly preferably 30° to 50°.

The irradiation time is preferably 1 minute to 60 minutes and more preferably 1 minute to 10 minutes.

In a case where patterning is required, a method of performing irradiation with light using a photomask as many times as necessary for pattern preparation or a method of writing a pattern by laser light scanning can be employed.

In the present invention, from the viewpoint of increasing the alignment degree of light absorption anisotropy, the alignment film preferably contains any of a polyvinyl alcohol-based resin, a cinnamoyl group-containing resin, or an epoxy resin, and more preferably contains a cinnamoyl group-containing resin.

In addition, in the present invention, from the viewpoint of improving the transfer quality of the light absorption anisotropic layer, it is preferable that at least one of the above-described protective layer or the above-described alignment film contains an additive having an active hydrogen reactive group. Examples of the additive having an active hydrogen reactive group include the above-described crosslinkable group-containing additives, in which the crosslinkable group is an active hydrogen reactive group.

For the same reason, it is preferable that at least one of the protective layer or the alignment film is any of a polyvinyl alcohol-based resin or an acrylate-based resin.

### (Bonding Layer)

The bonding layer in the laminate according to the embodiment of the present invention is a pressure sensitive adhesive layer or an adhesive layer.

### <Pressure Sensitive Adhesive Layer>

Examples of the pressure sensitive adhesive contained in the pressure sensitive adhesive layer include a rubber-based pressure sensitive adhesive, an acrylic pressure sensitive adhesive, a silicone-based pressure sensitive adhesive, a urethane-based pressure sensitive adhesive, a vinyl alkyl ether-based pressure sensitive adhesive, a polyvinyl alcohol-based pressure sensitive adhesive, a polyvinylpyrrolidone-based pressure sensitive adhesive, a polyacrylamide-based pressure sensitive adhesive, and a cellulose-based pressure sensitive adhesive.

Among those, the acryl-based pressure sensitive adhesive (adhesive that is sensitive to a pressure) is preferable from the viewpoints of transparency, weather fastness, heat resistance, and the like.

The pressure sensitive adhesive layer can be formed by a method of coating a release sheet with a solution of a pressure sensitive adhesive, drying the solution, and transferring the sheet to a surface of a transparent resin layer or a method of directly coating a surface of a transparent resin layer with a solution of a pressure sensitive adhesive and drying the solution.

For example, the solution of the pressure-sensitive adhesive is prepared as a solution of about 10% to 40% by mass in which the pressure sensitive adhesive is dissolved or dispersed in a solvent such as toluene and ethyl acetate.

As the application method, a roll coating method such as reverse coating or gravure coating, a spin coating method, a screen coating method, a fountain coating method, a dipping method, and a spraying method can be employed.

In addition, examples of a constituent material of the release sheet include appropriate thin paper bodies, for example, synthetic resin films such as polyethylene, polypropylene, and polyethylene terephthalate, rubber sheets, paper, cloth, nonwoven fabrics, nets, foam sheets, and metal foils.

### <Adhesive Layer>

The adhesive layer is a layer that exhibits adhesiveness due to drying or a reaction after bonding.

A polyvinyl alcohol-based adhesive (PVA-based adhesive) exhibits adhesiveness due to drying, and is capable of bonding materials to each other.

Specific examples of the curable adhesive which exhibits adhesiveness due to a reaction include an active energy ray-curable adhesive such as a (meth)acrylate-based adhesive and a cationic polymerization curable adhesive. The (meth)acrylate denotes acrylate and/or methacrylate. Examples of the curable component in the (meth)acrylate-based adhesive include a compound having a (meth)acryloyl group and a compound having a vinyl group.

In addition, as the cationic polymerization curable adhesive, a compound having an epoxy group or an oxetanyl group can also be used. The compound having an epoxy group is not particularly limited as long as it has at least two epoxy groups in the molecule, and various generally known curable epoxy compounds can be used. Preferable examples of the epoxy compound include a compound (aromatic epoxy compound) having at least two epoxy groups and at least one aromatic ring in the molecule and a compound (alicyclic epoxy compound) having at least two epoxy groups in the molecule, in which at least one of the epoxy groups is formed between two adjacent carbon atoms constituting an alicyclic ring.

The thickness of the bonding layer is not particularly limited, but is preferably 3 μm to 50 μm, more preferably 4 μm to 40 μm, and still more preferably 5 μm to 30 μm.

### [Other Layer Configurations]

It is preferable that the laminate according to the embodiment of the present invention further has at least one layer of a polarizer layer, an antireflection layer, or a retardation layer.

### <Polarizer Layer>

The polarizer layer is not particularly limited as long as it is a member functioning to convert light into specific linearly polarized light. An absorption-type polarizer or a reflection-type polarizer which has been known can be used.

An iodine-based polarizer, a dye-based polarizer using a dichroic dye, a polyene-based polarizer, or the like is used as the absorptive type polarizer. The iodine-based polarizer and the dye-based polarizer include a coating type polarizer and a stretching type polarizer, and any of these polarizers can be applied, but a coating type polarizer is preferable.

In addition, examples of a method of obtaining a polarizer by carrying out stretching and dying in a state of a laminated film in which a polyvinyl alcohol layer is formed on a base material include the methods disclosed in JP5048120B, JP5143918B, JP4691205B, JP4751481B, and JP4751486B, and known technologies relating to these polarizers can also be preferably used.

Examples of the coating type polarizer include those in WO2018/124198A, WO2018/186503A, WO2019/132020A, WO2019/132018A, WO2019/189345A, JP2019-197168A, JP2019-194685A, and JP2019-139222A, and known techniques relating to these polarizers can also be preferably used.

A polarizer in which thin films having different birefringence are laminated, a wire grid-type polarizer, a polarizer having a combination of a cholesteric liquid crystal having a selective reflection range, a ¼ wavelength plate, and the like is used as the reflective type polarizer.

Among these, from the viewpoint of more excellent adhesiveness, a polarizer including a polyvinyl alcohol-based resin (a polymer including —CH₂—CHOH— as a repeating unit, in particular, at least one selected from the group consisting of a polyvinyl alcohol and an ethylene-vinyl alcohol copolymer) is preferable.

In addition, from the viewpoint of imparting crack resistance, the polarizer may have a depolarization unit formed along the opposite end edges. Examples of the depolarization unit include JP2014-240970A.

In addition, the polarizer may have non-polarizing parts arranged at predetermined intervals in the long-length direction and/or the width direction. The non-polarizing part is a decolorized part which is partially decolorized. The arrangement pattern of the non-polarizing parts can be appropriately set according to a purpose. For example, the non-polarizing parts are arranged at a position corresponding to a camera unit of an image display device in a case where a polarizer is cut (cut, punched, or the like) to a predetermined size in order to be attached to the image display device in a predetermined size. Examples of the arrangement pattern of the non-polarizing parts include those in JP2016-27392A.

### <Antireflection Layer>

The antireflection layer is not particularly limited, and a known antireflection layer can be used.

Examples of the antireflection layer include the antireflection layers described in paragraphs 0108 to 0121 of WO2016/047648A, the contents of which are incorporated in the present specification.

### <Retardation Layer>

The retardation layer is not particularly limited, and a known retardation layer can be used.

Examples of the retardation layer include a stretched polycarbonate film, a stretched norbornene-based polymer film, a transparent film containing aligned inorganic particles having birefringence, such as strontium carbonate, a thin film in which oblique deposition of an inorganic dielectric is performed on a support, a film in which the liquid crystal compound is uniaxially aligned and the alignment is fixed, and the like.

In addition, as the retardation layer, a film in which the above-described liquid crystal compound is uniaxially aligned and fixed is preferable.

### [Image Display Device]

The image display device is an image display device having the laminate according to the embodiment of the present invention.

The display element used in the image display device according to the embodiment of the present invention is not particularly limited, and examples thereof include a liquid crystal cell, an organic EL display panel, an inorganic EL display panel, and a plasma display panel.

### [Liquid Crystal Display Device]

As a liquid crystal display device which is an example of the image display device according to the embodiment of the present invention, a form of a liquid crystal display device including the above-described laminate according to the embodiment of the present invention and a liquid crystal cell is preferably exemplified.

As a specific configuration, there is a configuration in which the laminate according to the embodiment of the present invention is disposed on the front-side polarizing plate or the rear-side polarizing plate. In these configurations, the viewing angle at which the vertical direction or the horizontal direction is light-shielded can be controlled.

In addition, the laminate according to the embodiment of the present invention may be disposed on both the front-side polarizing plate and the rear-side polarizing plate. With such a configuration, it is possible to control the viewing angle in which omniazimuth is light-shielded and light is transmitted only in the front direction.

Further, a plurality of the laminates according to the embodiment of the present invention may be laminated with each other with a retardation layer being interposed therebetween. Transmission performance and light shielding performance can be controlled by controlling a retardation value and an optical axis direction. For example, by disposing a polarizer, the laminate according of the embodiment of the present invention, a V/2 wavelength plate (the axial angle is an angle deviated by 45° from the alignment direction of the polarizer), and the laminate according to the embodiment of the present invention, all azimuths are shielded, and a viewing angle control in which light is transmitted only in the front direction can be performed. As a retardation layer, a positive A-plate, a negative A-plate, a positive C-plate, a negative C-plate, a B-plate, an O-plate, or the like can be used. From the viewpoint of reducing the thickness of the viewing angle control system, the thickness of the retardation layer is preferably small as long as the optical characteristics, mechanical properties, and manufacturing suitability are not impaired, and specifically, the thickness is preferably 1 to 150 μm, more preferably 1 to 70 μm, and still more preferably 1 to 30 μm.

Hereinafter, the liquid crystal cell constituting the liquid crystal display device will be described in detail.

### <Liquid Crystal Cell>

It is preferable that the liquid crystal cell used for the liquid crystal display device is in a vertical alignment (VA) mode, an optically compensated bend (OCB) mode, an in-plane-switching (IPS) mode, or a twisted nematic (TN) mode, but the present invention is not limited thereto.

In the liquid crystal cell in a TN mode, rod-like liquid crystalline molecules are substantially horizontally aligned at the time of no voltage application and further twisted aligned at 600 to 120°. The liquid crystal cell in a TN mode is most frequently used as a color TFT liquid crystal display device and is described in a plurality of documents.

In the liquid crystal cell in a VA mode, rod-like liquid crystalline molecules are substantially vertically aligned at the time of no voltage application. The concept of the liquid crystal cell in a VA mode includes (1) a liquid crystal cell in a VA mode in a narrow sense where rod-like liquid crystalline molecules are aligned substantially vertically at the time of no voltage application and substantially horizontally at the time of voltage application (described in JP1990-176625A (JP-H2-176625A)), (2) a liquid crystal cell (in an MVA mode) (SID97, described in Digest of tech. Papers (proceedings) 28 (1997) 845) in which the VA mode is formed to have multi-domain in order to expand the viewing angle, (3) a liquid crystal cell in a mode (n-ASM mode) in which rod-like liquid crystalline molecules are substantially vertically aligned at the time of no voltage application and twistedly multi-domain aligned at the time of voltage application (described in proceedings of Japanese Liquid Crystal Conference, pp. 58 to 59 (1998)), and (4) a liquid crystal cell in a SURVIVAL mode (presented at LCD International 98). In addition, the liquid crystal cell may be of any of a patterned vertical alignment (PVA) type, a photo-alignment (optical alignment) type, or a polymer-sustained alignment (PSA). The details of these modes are described in JP2006-215326A and JP2008-538819A.

In the liquid crystal cell in an IPS mode, liquid crystal compounds are aligned substantially parallel to the substrate, and the liquid crystalline molecules respond planarly through application of an electric field parallel to the substrate surface. That is, the liquid crystal compounds are aligned in the plane in a state where no electric field is applied. In the IPS mode, black display is carried out in a state where no electric field is applied, and absorption axes of a pair of upper and lower polarizing plates are orthogonal to each other. A method of reducing light leakage during black display in an oblique direction and improve the viewing angle using an optical compensation sheet is disclosed in JP1998-54982A (JP-H10-54982A), JP1999-202323A (JP-H11-202323A), JP1997-292522A (JP-H9-292522A), JP1999-133408A (JP-H11-133408A), JP1999-305217A (JP-H11-305217A), and JP1998-307291A (JP-H10-307291A).

### [Organic EL Display Device]

As an organic EL display device which is an example of the image display device according to the embodiment of the present invention, an aspect of a display device including the above-described laminate according to the embodiment of the present invention, a λ/4 plate, and an organic EL display panel in this order from the viewing side is suitably exemplified. In addition, similarly to the above-described liquid crystal display device, a plurality of the laminates according to the embodiment of the present invention may be laminated with a retardation layer therebetween and disposed on an organic EL display panel. Transmission performance and light shielding performance can be controlled by controlling a retardation value and an optical axis direction.

In addition, the organic EL display panel is a display panel constituted by using an organic EL element obtained by sandwiching an organic light emitting layer (organic electroluminescence layer) between electrodes (between a cathode and an anode). The configuration of the organic EL display panel is not particularly limited, and a known configuration is employed.

### [Viewing Angle Switching Device]

The image display device according to the embodiment of the present invention may be an image display device including the laminate according to the embodiment of the present invention and an electronically controlled viewing-angle switching cell, that is, a viewing angle switching device.

Here, the electronically controlled viewing-angle switching cell includes a first substrate, a second substrate, a first electrode, a second electrode, and a liquid crystal layer.

The first electrode and the second electrode that are disposed to face each other are installed on the first substrate and the second substrate, respectively, and the first electrode and the second electrode are, for example, surface electrodes, but the present invention is not limited thereto.

The liquid crystal layer is disposed between the first electrode and the second electrode and includes a plurality of liquid crystal molecules. The materials of the first substrate and the second substrate include glass, quartz, an organic polymer, or other appropriate transparent materials.

On the other hand, the first electrode and the second electrode are, for example, a light-transmitting electrode, and the material of the light-transmitting electrode includes indium tin oxide, indium zinc oxide, aluminum tin oxide, aluminum zinc oxide, or other appropriate oxides, a very thin metal, a hollow metal layer (metal mesh or wire grid), carbon nanotube, a silver nano wire (Ag nano wire), or graphene. For example, in a case where a voltage is applied between the first electrode and the second electrode, the voltage forms an electric field between the two electrodes and can rotate the liquid crystal molecules of the liquid crystal layer. In other words, the alignment axes (or major axes) of the plurality of liquid crystal molecules can be changed depending on the magnitude and distribution of the different electric fields, the polarization state of the ray can be adjusted, and the display device can be switched between the peeping prevention mode and the sharing mode. In a case where an electric field is not applied, the optical axes of the plurality of liquid crystal molecules in the liquid crystal layer are arranged in a specific direction. Therefore, the electronically controlled viewing-angle switching cell further includes the alignment film 1 and the alignment film 2. The alignment film 1 is provided between the first electrode and the liquid crystal layer, the alignment film 2 is provided between the second electrode and the liquid crystal layer, and the liquid crystal layer LCL is disposed between the alignment film 1 and the alignment film 2.

Specific examples thereof include an optical device/viewing angle switching device described in US2021/0349335, and the laminate according to the present application can also be suitably used in these devices.

In the present invention, in a case where the electronically controlled viewing-angle switching cell is used in the privacy mode, the maximum phase difference of the electronically controlled viewing-angle switching cell is preferably ¼ wavelength or ½ wavelength for a reason that the performance of the viewing angle control, that is, a difference in contrast of a screen in a case of being observed from the front and a case of being observed obliquely is likely to be the highest.

### [Optical Device/Head-Mounted Display]

The optical device is an optical device including the optical filter including the above-described laminate according to the embodiment of the present invention and a light guide plate in which a diffraction element is disposed on a surface.

In addition, the head-mounted display according to the embodiment of the present invention is a head-mounted display including the above-described optical device and an image display element.

FIG. 1 shows a schematic view of an example of the head-mounted display according to the embodiment of the present invention.

A head-mounted display 80 shown in FIG. 1 is an example of an AR glass, and includes a light guide plate 82, an incidence diffraction element 90 and an emission diffraction element 92 which are arranged on one surface of the light guide plate 82, an optical filter 10, and an image display element 86. The light guide plate 82, the incidence diffraction element 90, the emission diffraction element 92, and the optical filter 10 constitute the optical device according to the embodiment of the present invention.

As shown in FIG. 1, the incidence diffraction element 90 is disposed on a surface (main surface) of the light guide plate 82 on one end part side. In addition, the emission diffraction element 92 is disposed on the surface of the light guide plate 82 on the other end part side.

The disposition position of the incidence diffraction element 90 corresponds to an incidence position of a video light I₁ from the image display element 86 to the light guide plate 82. On the other hand, the disposition position of the emission diffraction element 92 corresponds to an emission position of the video light I₁ from the light guide plate 82, that is, an observation position of the video light I₁ by the user. In addition, the incidence diffraction element 90 and the emission diffraction element 92 are arranged on the same surface of the light guide plate 82.

In addition, the optical filter 10 faces the emission diffraction element 92 of the light guide plate 82, and is disposed on a surface of the light guide plate 82 opposite to the surface where the emission diffraction element 92 is disposed. As shown in FIG. 1, the optical filter 10 has the same planar shape as the emission diffraction element 92.

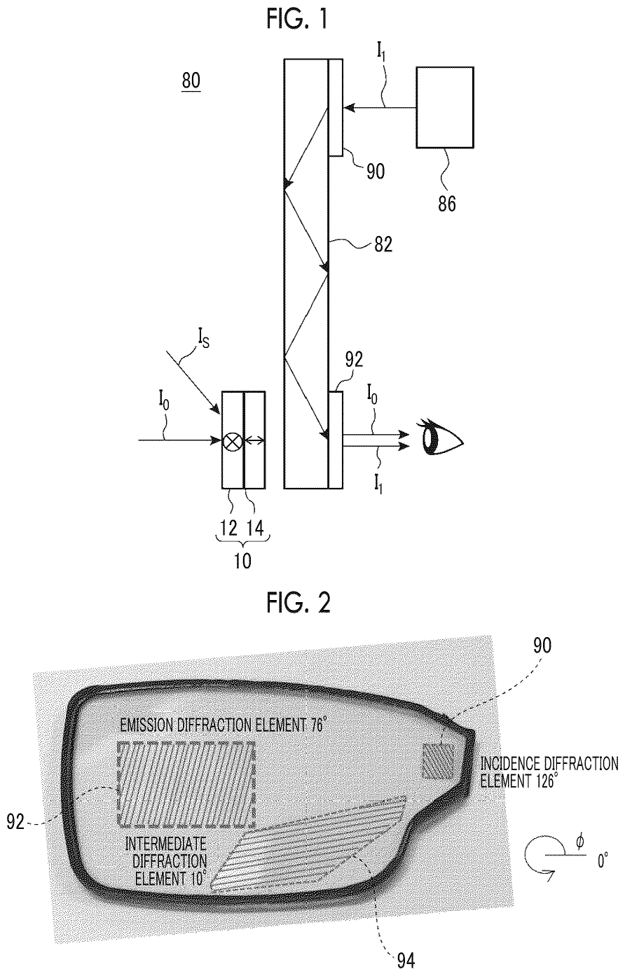

An intermediate diffraction element 94 may be provided in the light guide plate 82 (see FIG. 2).

In addition, the disposition position of each diffraction element is not limited to the end part of the light guide plate, and various positions can be used depending on the shape of the light guide plate, or the like.

In the head-mounted display 80 (AR glass) having such a configuration, the video light I₁ displayed by the image display element 86 is incident into the light guide plate 82 at an angle at which the video light I₁ is diffracted by the incidence diffraction element 90 and totally reflected at an interface between the light guide plate 82 and air.

The video light I₁ incident into the light guide plate 82 is totally reflected by both surfaces of the light guide plate 82, guided inside the light guide plate 82, and incident into the emission diffraction element 92.

The video light I₁ incident into the emission diffraction element 92 is diffracted by the emission diffraction element 92 in a direction perpendicular to the surface of the emission diffraction element 92.

The video light I₁ diffracted by the emission diffraction element 92 is emitted to an observation position by the user outside the light guide plate 82 to be observed by the user.

In addition, as shown in FIG. 1, an external light I₀ incident into the head-mounted display 80 from a front direction, that is, a background is transmitted through the optical filter 10, incident on the light guide plate 82, transmitted through the emission diffraction element 92, and reaches the observation position by the user. In the following description, the external light incident into the head-mounted display 80 from the front direction is also referred to as a front external light I₀.

As a result, the head-mounted display 80 displays a virtual video superimposed on the actual scene viewed by the user by propagating the video displayed by the image display element 86 by being incident on one end of the light guide plate 82 and being emitted from the other end.

The planar shape of the optical filter 10 is not limited to the same shape as the planar shape of the diffraction element, may have a different shape or a different size. However, in order to suitably shield external light incident into the diffraction element from an oblique direction, that is, oblique external light I_{S} and to suppress unnecessary light shielding of the background, that is, the front external light I₀, it is preferable that the diffraction element and the optical filter have the same planar shape including the size.

The light guide plate 82 is not particularly limited, and a known light guide plate used in an image display device or the like in the related art, such as a light guide plate used in various AR glasses and a light guide plate used in a backlight unit of a liquid crystal display device, can be used.

The image display element 86 is not limited, and various known image display elements (displays) used in various image display devices such as AR glass can be used.

Examples of the image display element 86 include a liquid crystal display (including liquid crystal on silicon (LCOS)), an organic electroluminescent display, an inorganic electroluminescent display, a digital light processing (DLP), a micro-electro-mechanical systems (MEMS)-type display, and a micro light-emitting diode (LED) display.

The image display element 86 may display a monochrome image, a two-color image, or a color image.

In the optical device according to the embodiment of the present invention, an optical filter including the laminate according to the embodiment of the present invention, which covers the diffraction element, is preferably provided, and as shown in the illustrated example, an optical filter including a laminate 14 and a polarizer 12 is provided.

The optical device according to the embodiment of the present invention includes the optical filter 10 (10 m) as described above, and thus, in a case of being used for a head-mounted display such as AR glass, the light transmittance in the front direction (front external light I₀) is high, that is, the visibility of the background is excellent, and rainbow-like unevenness caused by the external light (oblique external light I_{S}) incident from the front overhead (obliquely forward overhead) of the observer can be suppressed. Furthermore, with the optical device according to the embodiment of the present invention, it is preferable that not only rainbow-like unevenness caused by the external light incident from the front of the observer's head above, but also rainbow-like unevenness caused by the external light incident from the oblique front above of the observer (oblique upward direction front) can be suppressed.

In the laminate 14 constituting the optical filter 10 of the optical device according to the embodiment of the present invention, an angle between an absorption axis (alignment direction of the liquid crystal compound) and a normal direction of the laminate 14 is 0° to 45°. That is, the laminate 14 has an absorption axis extending in a normal direction of the main surface of the laminate 14 and a normal direction of the main surface of the light guide plate 82.

On the other hand, the polarizer 12 constituting the optical filter 10 is a polarizer having an absorption axis in the main surface. That is, the polarizer has an absorption axis parallel to the main surface of the laminate 14 and the main surface of the light guide plate 82.

In the present invention, in a case where the optical filter includes the laminate 14 and the polarizer 12, from the viewpoint of improving light resistance, it is preferable that the laminate 14 is disposed on the light guide plate 82 side.

### EXAMPLES

Hereinbelow, the present invention will be described in more detail with reference to Examples. The materials, the amounts of materials used, the ratios, the treatment details, the treatment procedure, or the like shown in the following Examples can be appropriately modified without departing from the spirit of the present invention. Therefore, the range of the present invention will not be restrictively interpreted by the following examples.

### Example 1

### (1) Support

The surface of a cellulose acylate film 1 (TG40, TAC base material having a thickness of 40 μm, manufactured by FUJIFILM Corporation) as a support was saponified with an alkaline solution and used.

### (2) Preparation of Alignment Film

The following composition 1 for forming an alignment film was applied to the cellulose acylate film 1. The support on which the coating film was formed was dried with hot air at 145° C. for 120 seconds to form an alignment film 1. The film thickness of the alignment film was 0.25 μm.

Composition 1 for Forming Alignment Film

| | |
|---|---|
| Polymer PA-1 shown below | 10.0 parts by mass |
| Acid generator PAG-1 shown below | 0.83 parts by mass |
| Stabilizer DIPEA shown below | 0.06 parts by mass |
| Butyl acetate | 100 parts by mass |
| Methyl ethyl ketone | 25 parts by mass |

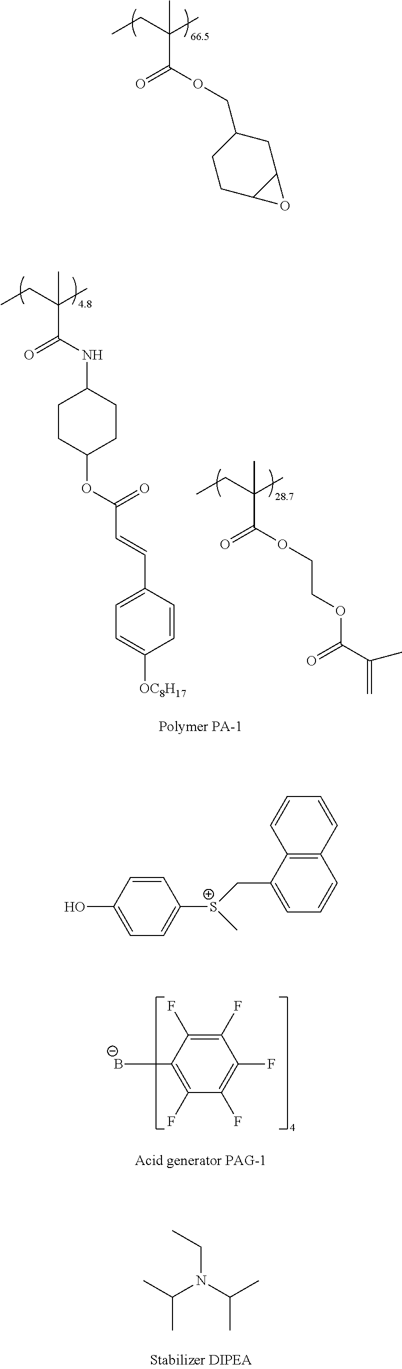

### (3) Preparation of Light Absorption Anisotropic Layer

The obtained TAC film with an alignment film was coated with a composition 1 for forming a light absorption anisotropic layer having the following composition using a wire bar, heated at 120° C. for 60 seconds, and cooled to 35° C. Next, the coating layer was heated at 75° C. for 60 seconds and cooled to room temperature again.

Thereafter, under a nitrogen purge condition (oxygen concentration: 100 ppm or less), the coating film was irradiated with light from the film normal direction for 2 seconds under an irradiation condition of an illuminance of 200 mW/cm² using an LED lamp (center wavelength: 365 nm) to prepare a light absorption anisotropic layer 1 on the alignment film. A film thickness of the light absorption anisotropic layer 1 was 4.5 μm.

Composition 1 for Forming Light Absorption Anisotropic Layer

| | |
|---|---|
| Dichroic substance D-1 shown below | 0.69 parts by mass |
| Dichroic substance D-2 shown below | 0.17 parts by mass |
| Dichroic substance D-3 shown below | 1.13 parts by mass |
| Polymer liquid crystal compound P-1 | 8.67 parts by mass |
| shown below | |
| Liquid crystal compound L-1 shown | 1.97 parts by mass |
| below | |
| IRGACURE OXE-2 (manufactured by | 0.20 parts by mass |
| BASF SE) | |
| Vertical alignment agent E-2 shown | 0.16 parts by mass |
| below | |
| Surfactant F-1 shown below | 0.007 parts by mass |
| Cyclopentanone | 78.17 parts by mass |
| Benzyl alcohol | 8.69 parts by mass |

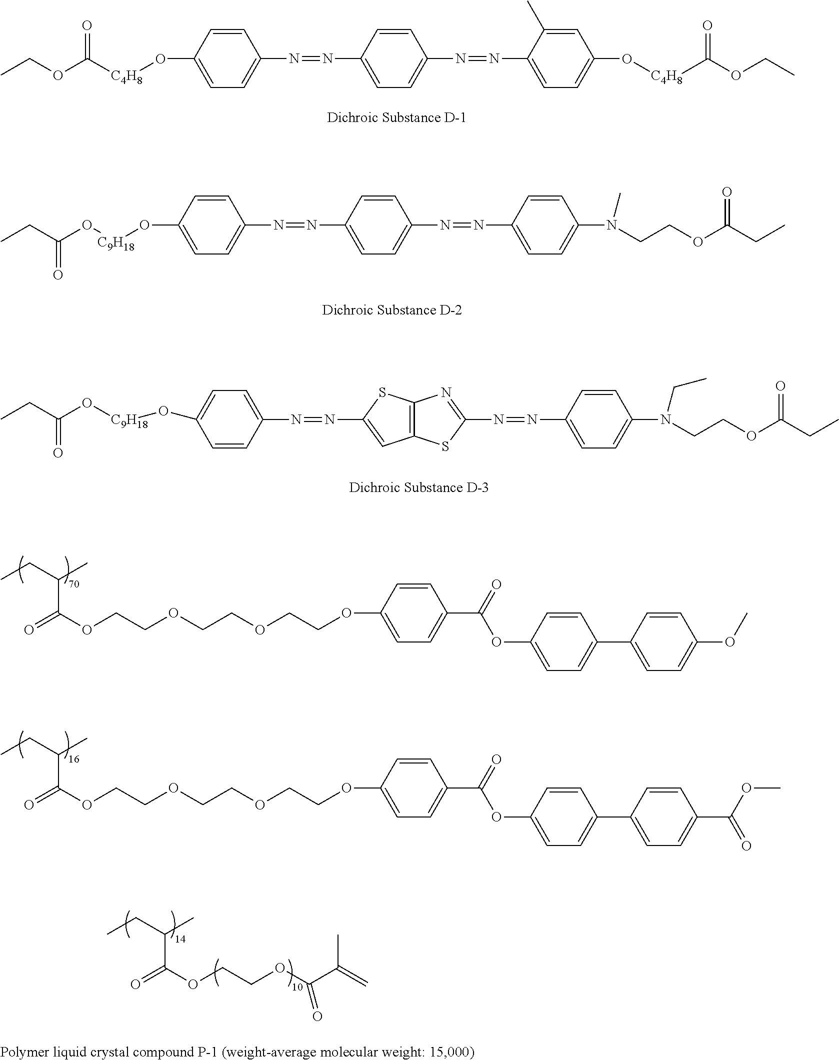

Liquid crystal compound L-1 [mixture of the following liquid crystal compounds (RA), (RB), and (RC) at a ratio of 84:14:2 (mass ratio)]

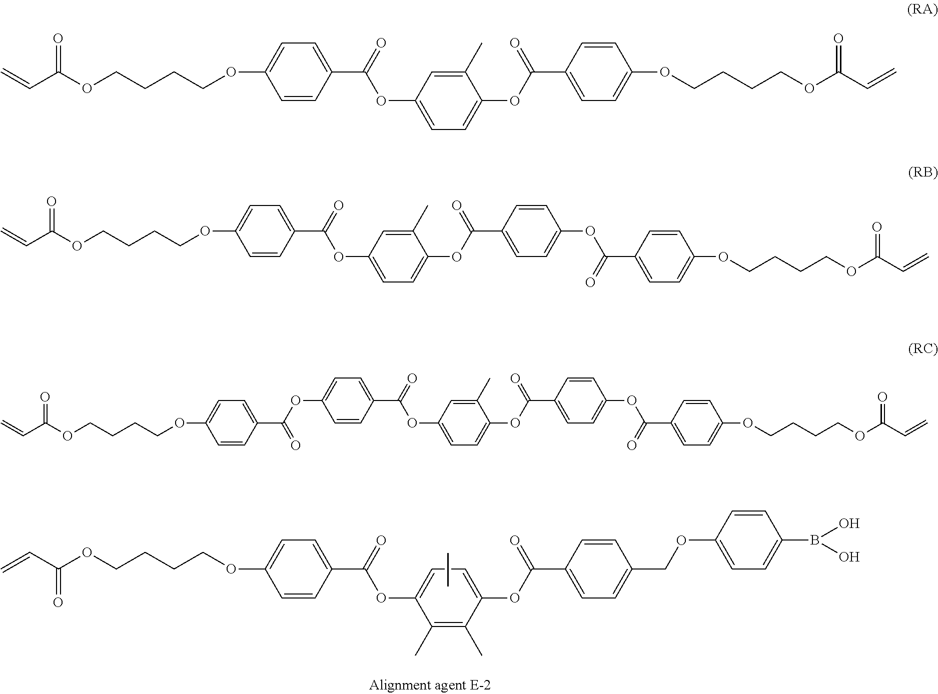

### Surfactant F-1 (Weight-Average Molecular Weight: 9,000)

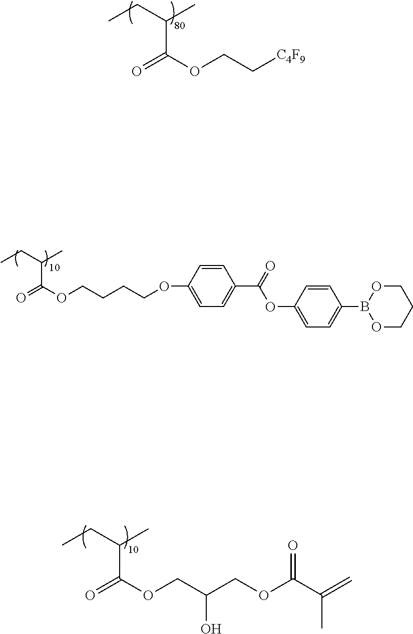

### (4) Preparation of Protective Layer

The surface of the obtained light absorption anisotropic layer 1 was subjected to a corona treatment under the conditions of 4.0 m/min, 440 W, and a clearance of 2.0 mm. Next, a coating liquid 1 for forming a protective layer having the following composition was applied onto the light absorption anisotropic layer 1 after the corona treatment with a wire bar to form a coating film.

Next, the support on which the coating film was formed was dried with hot air at 60° C. for 60 seconds and further dried with hot air at 100° C. for 120 seconds to form a protective layer 1.

Thereafter, under a nitrogen purge condition (oxygen concentration: 100 ppm or less), the protective layer 1 was formed on the light absorption anisotropic layer 1 by irradiating the light absorption anisotropic layer 1 with light for 2 seconds using an LED lamp (central wavelength: 365 nm) under an irradiation condition of an illuminance of 200 mW/cm² from the film normal direction, thereby preparing a laminate precursor 1 (layer configuration: support 1/alignment film 1/light absorption anisotropic layer 1/protective layer 1). A film thickness of the protective layer was 0.5 μm.

Coating liquid 1 for forming protective layer

| | |
|---|---|
| Modified polyvinyl alcohol PVA-1 shown below | 3.80 parts by mass |
| IRGACURE 2959 (manufactured by BASF SE) | 0.20 parts by mass |
| Coloring agent compound G-1 shown below | 0.08 parts by mass |
| Water | 70 parts by mass |
| Methanol | 30 parts by mass |

### Modified Polyvinyl Alcohol PVA-1

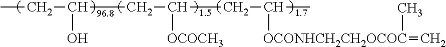

### Coloring Agent Compound G-1

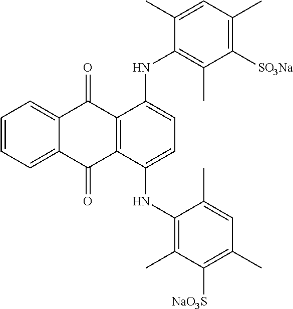

### (5) Preparation of Pressure Sensitive Adhesive Sheet

An acrylate-based polymer was prepared according to the following procedure.

First, 95 parts by mass of butyl acrylate and 5 parts by mass of acrylic acid were polymerized by a solution polymerization method in a reaction container equipped with a cooling pipe, a nitrogen introduction pipe, a thermometer, and a stirrer, thereby obtaining an acrylate-based polymer A1 with an average molecular weight of 2,000,000 and a molecular weight distribution (Mw/Mn) of 3.0.

Next, the obtained acrylate-based polymer A1 (100 parts by mass), coronate L (75% by mass ethyl acetate solution of trimethylolpropane adduct of tolylene isocyanate, number of isocyanate groups in one molecule: 3, manufactured by Nippon Polyurethane Industry Co., Ltd.) (1.0 parts by mass), and a silane coupling agent KBM-403 (manufactured by Shin-Etsu Chemical Co., Ltd.) (0.2 parts by mass) were mixed with each other, and ethyl acetate was finally added to the mixture such that the concentration of the total solid contents reached 10% by mass, thereby preparing a composition for forming a pressure sensitive adhesive.

This composition was applied to a release PET film (manufactured by FUJIMORI KOGYO CO., LTD., film binder, light release type) using a die coater, and dried for 1 minute in an environment of 90° C. to obtain an acrylate-based pressure sensitive adhesive sheet consisting of a pressure sensitive adhesive layer and a release PET film. The film thickness was 25 μm, and the storage elastic modulus was 0.1 MPa.

### (6) Preparation of Pressure Sensitive Adhesive Layer

The surface of the pressure sensitive adhesive layer of the acrylate-based pressure sensitive adhesive sheet obtained above was bonded to the protective layer of the laminate precursor 1, the release PET on the pressure sensitive adhesive sheet side was peeled off, and the pressure sensitive adhesive layer 1 was formed on the protective layer 1, thereby obtaining the following layer configuration.

Layer configuration: support 1/alignment film 1/light absorption anisotropic layer 1/protective layer 1/pressure sensitive adhesive layer 1

### (7) Peeling of Support

The pressure sensitive adhesive layer 1 exposed by peeling the release PET was bonded to another release PET film (manufactured by Fujimori Kogyo Co., Ltd., film binder, medium release type), and then the support 1 adjacent to the alignment film 1 was peeled off to obtain the following layer configuration.

Layer configuration: alignment film 1/light absorption anisotropic layer 1/protective layer 1/pressure sensitive adhesive layer 1/release PET (medium release type)

### (8) Preparation of Bonding Layer

The surface of the pressure sensitive adhesive layer of the pressure sensitive adhesive sheet prepared in the section (5) was bonded to the surface of the alignment film 1 exposed by peeling the support 1, and then the release PET (light release type) on the pressure sensitive adhesive sheet side was peeled off to prepare a laminate having the following layer configuration. In this manner, the exposed pressure sensitive adhesive layer corresponds to the bonding layer. Layer configuration: pressure sensitive adhesive layer (bonding layer)/alignment film 1/light absorption anisotropic layer 1/protective layer 1/pressure sensitive adhesive layer 1/release PET (medium release type)

### Example 2

A laminate of Example 2 was prepared in the same manner as in Example 1, except that the composition 1 for forming a light absorption anisotropic layer was changed to the following composition 2 for forming a light absorption anisotropic layer.

Composition 2 for forming light absorption anisotropic layer

| | |
|---|---|
| Dichroic substance D-1 shown above | 0.69 parts by mass |
| Dichroic substance D-2 shown above | 0.17 parts by mass |
| Dichroic substance D-3 shown above | 1.13 parts by mass |
| Polymer liquid crystal compound P-1 | 8.67 parts by mass |
| shown above | |
| Liquid crystal compound L-1 shown | 1.97 parts by mass |
| above | |
| Crosslinkable group-containing additive | 1.00 part by mass |
| 1 (1,10-decanediol diacrylate, A-600 | |
| manufactured by Shin-Nakamura Chemical | |
| Co., Ltd.) | |
| IRGACURE OXE-2 (manufactured by | 0.20 parts by mass |
| BASF SE) | |
| Vertical alignment agent E-2 shown | 0.16 parts by mass |
| above | |
| Surfactant F-1 shown above | 0.007 parts by mass |
| Cyclopentanone | 78.17 parts by mass |
| Benzyl alcohol | 8.69 parts by mass |

### Example 3

A laminate of Example 3 was prepared in the same manner as in Example 1, except that the composition 1 for forming a light absorption anisotropic layer was changed to the following composition 3 for forming a light absorption anisotropic layer.

Composition 3 for forming light absorption anisotropic layer

| | |
|---|---|
| Dichroic substance D-1 shown above | 0.69 parts by mass |
| Dichroic substance D-2 shown above | 0.17 parts by mass |
| Dichroic substance D-3 shown above | 1.13 parts by mass |
| Polymer liquid crystal compound P-1 shown | 8.67 parts by mass |
| above | |
| Liquid crystal compound L-1 shown above | 1.97 parts by mass |
| Crosslinkable group-containing additive 2 | 1.00 part by mass |
| (bisphenol A type bifunctional epoxy resin, | |
| jER828US manufactured by Mitsubishi Chemical | |
| Corporation) | |
| Photoacid generator (CPI-100P, manufactured | 0.10 parts by mass |
| by San-Apro Ltd.) | |
| IRGACURE OXE-2 (manufactured by BASF SE) | 0.20 parts by mass |
| Vertical alignment agent E-1 shown below | 0.16 parts by mass |
| Surfactant F-1 shown above | 0.007 parts by mass |
| Cyclopentanone | 78.17 parts by mass |
| Benzyl alcohol | 8.69 parts by mass |

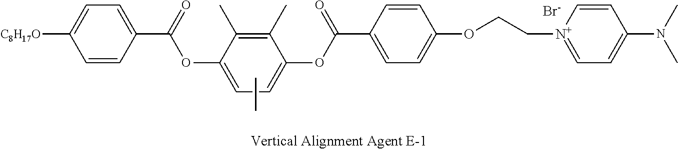

### Example 4

A laminate of Example 4 was prepared in the same manner as in Example 1, except that the composition 1 for forming a light absorption anisotropic layer was changed to the following composition 4 for forming a light absorption anisotropic layer.

Composition 4 for forming light absorption anisotropic layer

| | |
|---|---|
| Dichroic substance D-1 shown above | 0.69 parts by mass |
| Dichroic substance D-2 shown above | 0.17 parts by mass |
| Dichroic substance D-3 shown above | 1.13 parts by mass |
| Polymer liquid crystal compound P-1 shown | 8.67 parts by mass |
| above | |
| Liquid crystal compound L-1 shown above | 1.97 parts by mass |
| Crosslinkable group-containing additive 2 | 1.00 part by mass |
| (bisphenol A type bifunctional epoxy resin, | |
| jER828US manufactured by Mitsubishi Chemical | |
| Corporation) | |
| Photoacid generator (CPI-100P, manufactured | 0.10 parts by mass |
| by San-Apro Ltd.) | |
| IRGACURE OXE-2 (manufactured by BASF SE) | 0.20 parts by mass |
| Alignment agent E-1 (ionic) shown above | 0.16 parts by mass |
| Alignment agent E-2 (boronic acid) shown | 0.16 parts by mass |
| above | |
| Surfactant F-1 shown above | 0.007 parts by mass |
| Cyclopentanone | 78.17 parts by mass |
| Benzyl alcohol | 8.69 parts by mass |

### Example 5

A laminate of Example 5 was prepared in the same manner as in Example 4, except that the composition 1 for forming an alignment film was changed to the following composition 2 for forming an alignment film.

Composition 2 for Forming Alignment Film

| | |
|---|---|
| Polymer PA-1 shown above | 10.0 parts by mass |
| Crosslinkable group-containing additive 2 | 3.00 parts by mass |
| (bisphenol A type bifunctional epoxy resin, | |
| jER828US manufactured by Mitsubishi Chemical | |
| Corporation) | |
| Acid generator PAG-1 shown above | 0.83 parts by mass |
| Stabilizer DIPEA shown above | 0.06 parts by mass |
| Butyl acetate | 100 parts by mass |
| Methyl ethyl ketone | 25 parts by mass |

### Example 6

A laminate of Example 6 was prepared in the same manner as in Example 3, except that the coating amount of the composition for forming a light absorption anisotropic layer was adjusted and the film thickness of the light absorption anisotropic layer was set to 1.0 μm.

### Example 7

A laminate of Example 7 was prepared in the same manner as in Example 3, except that the composition 1 for forming an alignment film was changed to the following composition 3 for forming an alignment film.

Composition 3 for Forming Alignment Film

| | |
|---|---|
| Polymer PA-1 shown above | 10.0 parts by mass |
| Acid generator PAG-1 shown above | 0.83 parts by mass |
| Stabilizer DIPEA shown above | 0.06 parts by mass |
| Butyl acetate | 60 parts by mass |
| Methyl ethyl ketone | 60 parts by mass |

### Example 8

A laminate of Example 8 was prepared in the same manner as in Example 3, except that the composition 1 for forming an alignment film was changed to the following composition 4 for forming an alignment film.

Composition 4 for Forming Alignment Film

| | |
|---|---|
| Polymer PA-1 shown above | 10.0 parts by mass |
| Acid generator PAG-1 shown above | 0.83 parts by mass |
| Stabilizer DIPEA shown above | 0.06 parts by mass |
| Butyl acetate | 125 parts by mass |

### Example 9

A laminate of Example 9 was prepared in the same manner as in Example 1, except that the composition 1 for forming a light absorption anisotropic layer was changed to the following composition 5 for forming a light absorption anisotropic layer.

Composition 5 for forming light absorption anisotropic layer

| | |
|---|---|
| Dichroic substance D-1 shown above | 0.69 parts by mass |
| Dichroic substance D-2 shown above | 0.17 parts by mass |
| Dichroic substance D-3 shown above | 1.13 parts by mass |
| Polymer liquid crystal compound P-1 shown | 8.67 parts by mass |
| above | |
| Liquid crystal compound L-1 shown above | 1.97 parts by mass |
| Crosslinkable group-containing additive 2 | 1.00 part by mass |
| (bisphenol A type bifunctional epoxy resin, | |
| jER828US manufactured by Mitsubishi Chemical | |
| Corporation) | |
| Photoacid generator (CPI-100P, manufactured | 0.10 parts by mass |
| by San-Apro Ltd.) | |
| IRGACURE OXE-2 (manufactured by BASF SE) | 0.20 parts by mass |
| Alignment agent E-2 (boronic acid) shown above | 0.16 parts by mass |
| Surfactant F-1 shown above | 0.007 parts by mass |
| Cyclopentanone | 78.17 parts by mass |
| Benzyl alcohol | 8.69 parts by mass |

### Example 10

A laminate of Example 10 was prepared in the same manner as in Example 3, except that the composition 3 for forming a light absorption anisotropic layer was changed to the following composition 6 for forming a light absorption anisotropic layer.

Composition 6 for Forming Light Absorption Anisotropic Layer

| | |
|---|---|
| Dichroic substance D-4 shown below | 1.82 parts by mass |
| Dichroic substance D-5 shown below | 0.49 parts by mass |
| Dichroic substance D-6 shown below | 3.25 parts by mass |
| Polymer liquid crystal compound P-1 shown | 18.21 parts by mass |
| above | |
| Liquid crystal compound L-1 shown above | 4.13 parts by mass |
| Crosslinkable group-containing additive 2 | 2.10 parts by mass |
| (bisphenol A type bifunctional epoxy resin, | |
| jER828US manufactured by Mitsubishi Chemical | |
| Corporation) | |
| Photoacid generator (CPI-100P, manufactured | 0.21 parts by mass |
| by San-Apro Ltd.) | |
| IRGACURE 369 (manufactured by BASF SE) | 1.67 parts by mass |
| Alignment agent E-1 shown above | 0.37 parts by mass |
| Alignment agent E-2 shown above | 0.37 parts by mass |
| BYK-361N (manufactured by BYK-Chemie | 0.084 parts by mass |
| GmbH) | |
| o-xylene | 69.60 parts by mass |

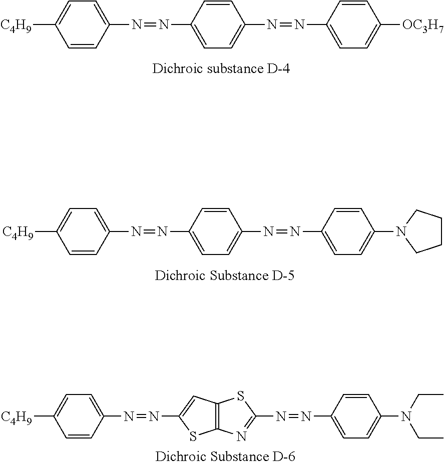

### Example 11

A laminate of Example 11 was prepared in the same manner as in Example 3, except that the composition 3 for forming a light absorption anisotropic layer was changed to the following composition 7 for forming a light absorption anisotropic layer.

Composition 7 for forming light absorption anisotropic layer

| | |
|---|---|
| Dichroic substance D-1 shown above | 0.79 parts by mass |
| Dichroic substance D-2 shown above | 0.21 parts by mass |
| Dichroic substance D-3 shown above | 1.41 parts by mass |
| Liquid crystal compound L-2 shown below | 7.52 parts by mass |
| Liquid crystal compound L-3 shown below | 2.51 parts by mass |
| Crosslinkable group-containing additive 2 | 0.94 parts by mass |
| (bisphenol A type bifunctional epoxy resin, | |
| jER828US manufactured by Mitsubishi Chemical | |
| Corporation) | |
| Photoacid generator (CPI-100P, manufactured | 0.094 parts by mass |
| by San-Apro Ltd.) | |
| IRGACURE 369 (manufactured by BASF SE) | 0.73 parts by mass |
| BYK-361N (manufactured by BYK-Chemie | 0.036 parts by mass |
| GmbH) | |
| Cyclopentanone | 78.13 parts by mass |
| Benzyl alcohol | 8.67 parts by mass |

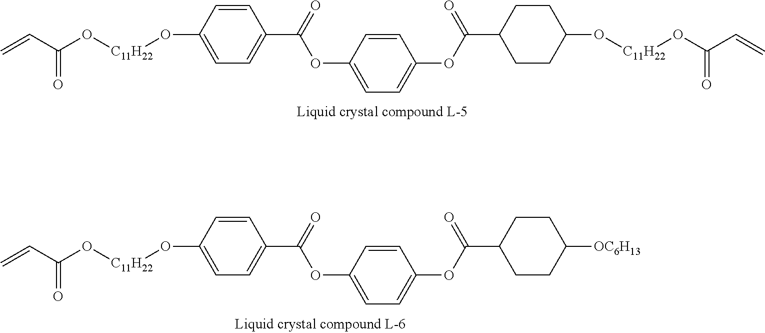

### Example 12

A laminate of Example 12 was prepared in the same manner as in Example 3, except that the composition 3 for forming a light absorption anisotropic layer was changed to the following composition 8 for forming a light absorption anisotropic layer.

Composition 8 for forming light absorption anisotropic layer

| | |
|---|---|
| Dichroic substance D-4 shown above | 0.78 parts by mass |
| Dichroic substance D-5 shown above | 0.21 parts by mass |
| Dichroic substance D-6 shown above | 1.39 parts by mass |
| Liquid crystal compound L-2 shown above | 7.39 parts by mass |
| Liquid crystal compound L-3 shown above | 2.46 parts by mass |
| Crosslinkable group-containing additive 2 | 0.99 parts by mass |
| (bisphenol A type bifunctional epoxy resin, | |
| jER828US manufactured by Mitsubishi Chemical | |
| Corporation) | |
| Photoacid generator (CPI-100P, manufactured | 0.099 parts by mass |
| by San-Apro Ltd.) | |
| IRGACURE 369 (manufactured by BASF SE) | 0.71 parts by mass |
| BYK-361N (manufactured by BYK-Chemie | 0.036 parts by mass |
| GmbH) | |
| o-xylene | 87.02 parts by mass |

### Example 13

A laminate of Example 15 was prepared in the same manner as in Example 5, except that the coating liquid 1 for forming a protective layer was changed to the following coating liquid 2 for forming a protective layer.

Coating liquid 2 for forming protective layer

| | |
|---|---|
| Polyfunctional acrylate (dipentaerythritol | 9.71 parts by mass |
| hexaacrylate) | |
| IRGACURE OXE-2 (manufactured by BASF SE) | 0.28 parts by mass |
| Surfactant F-1 shown above | 0.01 parts by mass |
| Methyl ethyl ketone | 90.00 parts by mass |

### Comparative Example 1

A laminate of Comparative Example 1 was prepared in the same manner as in Example 3, except that the support adjacent to the alignment film 1 was not peeled off. The layer configuration of Comparative Example 1 is shown below.

Layer configuration: pressure sensitive adhesive layer (bonding layer)/support 1/alignment film 1/light absorption anisotropic layer 1/protective layer 1/pressure sensitive adhesive layer 1/release PET (medium release type)

### [Evaluation]

### (1) Transmittance Central Axis Angle θ

For the laminates prepared in Examples 1 to 13 and Comparative Example 1, the transmittance central axis angle θ was measured by the method described above. The results are shown in Table 1 below.

### (2) Transfer Quality of Light Absorption Anisotropic Layer

The laminates prepared in Examples 1 to 13 and Comparative Example 1 were overlaid on the polarizer such that the surface of the bonding layer of the laminate was on the lower side, and the transfer quality of the light absorption anisotropic layer was evaluated by visual observation from the direction of the polar angle of 45° in the transmission axis direction of the polarizer according to the following standards. The results are shown in Table 1 below.

### <Evaluation Standard>

A: Even in a case where the image is enlarged with a loupe, the presence of elongation, tearing, wrinkles, folding, and the like is not recognized.

B: There is no elongation, breakage, wrinkle, folding, or the like that can be visually recognized at a glance, but it is found that there is a very small amount of the elongation, breakage, wrinkle, folding, or the like when magnified with a loupe.

C: There is no elongation, breakage, wrinkle, folding, or the like that is visually recognized at a glance, but it is found that there is a slight elongation, breakage, wrinkle, folding, or the like in a case of being magnified with a loupe.

D: There are no elongation, breakage, wrinkles, folding, or the like that can be visually recognized at a glance, but there are relatively many elongation, breakage, wrinkles, folding, or the like that can be recognized by magnification with a loupe.

E: There is a very small amount of elongation, tearing, wrinkles, folding, and the like that can be visually recognized at a glance.

F: There are slight elongation, tearing, wrinkles, folding, and the like that can be visually recognized at a glance.

### (3) Flexibility of Laminate

For the laminates prepared in Examples 1 to 13 and Comparative Example 1, the surface of the bonding layer of the laminate was attached to a TAC film having a thickness of m, and then the release PET (medium release type) was peeled off to obtain a laminate having the following layer configuration.

Layer configuration: TAC/pressure sensitive adhesive layer (bonding layer)/alignment film/light absorption anisotropic layer/protective layer

Thereafter, the laminate was subjected to a mandrel tester, overlaid on a polarizer, and visually observed from a polar angle of 45° in a direction of a transmission axis direction of the polarizer, and the flexibility of the laminate was evaluated according to the following standard. The results are shown in Table 1 below.

### <Evaluation Standard>

A: There are no elongation, breakage, wrinkles, folding, or the like that are visually recognized at a glance.

B: There are strong elongation, tearing, wrinkles, folding, and the like that are visually recognized at a glance.

TABLE 1

| | | Light absorption anisotropic layer | | | | | |
|---|---|---|---|---|---|---|---|
| | | | | | | | Difference of |
| | | Kind of composition | | | Alignment | | alignment degrees |
| | | for forming light | | Content of | degree at | Haze | at wavelength of |
| | Protective | absorption | Thickness | dichroic | wavelength | value | 450 nm, 550 nm, |
| | layer | anisotropic layer | (μm) | substance | of 550 nm | (%) | 650 nm |
| Example 1 | PVA | composition 1 | 4.5 | 229 mg/cm³ | 0.96 | 0.3 | 0.015 |
| Example 2 | PVA | composition 2 | 4.5 | 244 mg/cm³ | 0.96 | 0.3 | 0.015 |
| Example 3 | PVA | composition 3 | 4.5 | 245 mg/cm³ | 0.96 | 0.3 | 0.014 |
| Example 4 | PVA | composition 4 | 4.5 | 248 mg/cm³ | 0.96 | 0.3 | 0.015 |
| Example 5 | PVA | composition 4 | 4.5 | 248 mg/cm³ | 0.96 | 0.3 | 0.016 |
| Example 6 | PVA | composition 3 | 1.0 | 245 mg/cm³ | 0.96 | 0.3 | 0.014 |
| Example 7 | PVA | composition 3 | 4.5 | 245 mg/cm³ | 0.96 | 0.3 | 0.015 |
| Example 8 | PVA | composition 3 | 4.5 | 245 mg/cm³ | 0.96 | 0.3 | 0.015 |
| Example 9 | PVA | composition 5 | 4.5 | 245 mg/cm³ | 0.96 | 0.3 | 0.015 |
| Example 10 | PVA | composition 6 | 4.5 | 562 mg/cm³ | 0.93 | 0.4 | 0.020 |
| Example 11 | PVA | composition 7 | 4.5 | 248 mg/cm³ | 0.93 | 0.4 | 0.020 |
| Example 12 | PVA | composition 8 | 4.5 | 244 mg/cm³ | 0.91 | 0.4 | 0.020 |
| Example 13 | Polyfunctional | composition 4 | 4.5 | 248 mg/cm³ | 0.96 | 0.3 | 0.015 |
| | acrylate | | | | | | |
| Comparative | PVA | composition 3 | 4.5 | 245 mg/cm³ | 0.96 | 0.5 | 0.022 |
| Example 1 | | | | | | | |

| | Alignment | | | | Transfer | |
|---|---|---|---|---|---|---|
| | film (kind of | | | | quality | |
| | composition | | | | of light | |
| | for forming | Presence | Transmittance | Peeling | absorption | |
| | alignment | or absence | central axis | force | anisotropic | Flexibility |
| | film) | of support | angle θ | N/25 mm | layer | of laminate |
| Example 1 | composition 1 | absence | 0° | 0.80 | E | A |
| Example 2 | composition 1 | absence | 0° | 0.80 | D | A |
| Example 3 | composition 1 | absence | 0° | 0.80 | C | A |
| Example 4 | composition 1 | absence | 0° | 0.80 | B | A |
| Example 5 | composition 2 | absence | 0° | 1.00 | A | A |
| Example 6 | composition 1 | absence | 0° | 1.00 | D | A |
| Example 7 | composition 3 | absence | 0° | 0.28 | F | A |
| Example 8 | composition 4 | absence | 0° | 0.10 | F | A |
| Example 9 | composition 1 | absence | 0° | 0.80 | D | A |
| Example 10 | composition 1 | absence | 0° | 0.75 | C | A |
| Example 11 | composition 1 | absence | 0° | 0.75 | C | A |
| Example 12 | composition 1 | absence | 0° | 0.75 | C | A |
| Example 13 | composition 2 | absence | 0° | 1.00 | A | A |
| Comparative | composition 1 | TAC | 0° | 0.80 | E | B |
| Example 1 | | | | | | |

From the results shown in Table 1, it was found that the laminate including the support between the alignment film and the bonding layer had poor flexibility in a case of being applied to a bending application (Comparative Example 1).

On the other hand, it was found that the laminate having the protective layer, the light absorption anisotropic layer, the alignment film, and the bonding layer adjacent to each other in this order has good flexibility (Examples 1 to 13).

In particular, from the comparison between Example 1 and Example 2, it was found that in a case where a crosslinkable group-containing additive was blended as a composition for forming a light absorption anisotropic layer, the transfer quality of the light absorption anisotropic layer was improved.

In addition, from the comparison between Example 3 and Example 9, it was found that in a case where a composition in which an additive having an active hydrogen reactive group as a crosslinking agent and an ionic vertical alignment agent were blended was used as the composition for forming the light absorption anisotropic layer, the transfer quality of the light absorption anisotropic layer was further improved.

Furthermore, from the comparison between Example 3 and Example 4, it was found that in a case where an ionic vertical alignment agent and a vertical alignment agent having a boronic acid group were used in combination as the vertical alignment agent, the transfer quality of the light absorption anisotropic layer was further improved.

Further, from the comparison between Example 4 and Example 5, it was found that in a case where the alignment film contains an additive having an active hydrogen reactive group, the transfer quality of the light absorption anisotropic layer is particularly good.

Although not described in Table 1, in a comparison between Example 5 and Example 13, it was found that, in a case where a sample before peeling off the release PET on the pressure sensitive adhesive sheet side was disposed in an environment of 80° C. and 85% relative humidity for 500 hours after bonding the pressure sensitive adhesive layer to the protective layer, Example 13 was able to suppress the change in transmittance.

### Example 14

### (1) Preparation of Laminate X

A laminate precursor 1 (layer configuration: support 1/alignment film 1/light absorption anisotropic layer 1/protective layer 1) was prepared by the same method as in Example 1.

Next, the pressure sensitive adhesive sheet was bonded to the protective layer of the above-described laminate precursor 1, the support of the pressure sensitive adhesive sheet was peeled off, and COSMOSHINE double-sided easy adhesion type A4360 (thickness: 75 μm, manufactured by Toyobo Co., Ltd.) was bonded to the exposed pressure sensitive adhesive layer to prepare a laminate X having the following layer configuration.

Layer configuration: alignment film 1/light absorption anisotropic layer 1/protective layer 1/pressure sensitive adhesive layer/support (COSMOSHINE double-sided easy adhesion type A4360)

### (2) Preparation of PVA Polarizing Plate

A PVA film having a film thickness of 30 μm, an average degree of polymerization of 2400, and a degree of saponification of 99.9 mol % was immersed in warm water at 25° C. for 120 seconds to swell the film. Next, the PVA film was dyed while being dipped in an aqueous solution having a concentration of 0.6 wt % of iodine/potassium iodide (weight ratio=2/3) and stretched to 2.1 times. Next, the film was stretched in a boric acid ester aqueous solution at 55° C. such that the total stretching ratio reached 5.5 times, was washed with water, and was dried to prepare a PVA polarizer. The thickness of the PVA polarizer was 8 μm. The saponified cellulose acylate film (TAC substrate having a thickness of 40 μm, TG40UL manufactured by FUJIFILM Corporation) was laminated on both surfaces of the PVA polarizer using a completely saponified polyvinyl alcohol 5% aqueous solution as an adhesive. Next, the polarizing element in which the TAC film was laminated was passed through a nip roller machine and then dried at 60° C. for 10 minutes to obtain a PVA polarizing plate.

### (3) Preparation of Optical Filter X

The TAC surface of the PVA polarizing plate and the surface of the alignment film 1 of the laminate X were bonded to each other with a photocurable adhesive (ARONIX LCR, manufactured by Toagosei Co., Ltd.), and the pressure sensitive adhesive layer on the laminate X side and the support were peeled off to prepare an optical filter X having the following layer configuration.

Layer configuration: PVA polarizing plate/photo-curable adhesive/alignment film 1/light absorption anisotropic layer 1/protective layer 1

### (4) Preparation of Head-Mounted Display X

A light-shielding lens on the right-side observation surface side of AR glasses (BLADE manufactured by Vuzix Corporation) was removed, and an optical filter was prepared to be superimposed on the light guide plate with the protective layer side facing the light guide plate side.

The optical filter X was superimposed on the reflective observation surface side of the light guide plate to cover the entire light guide plate, and the cover glass was installed on a side of the optical filter X opposite to the light guide plate side via a pressure sensitive adhesive to prepare a head-mounted display X.

In the AR glasses, the incidence diffraction element, the emission diffraction element, and the intermediate diffraction element were provided on the surface of the light guide plate as in FIG. 1. In addition, as described above, the observation surface was the surface of the user side who used the AR glasses, and the opposite observation surface side was the surface opposite to the user who used the AR glasses, that is, the surface into which external light was incident.

### Example 15

### (1) Preparation of Laminate X

Two laminates X having the following layer configuration were prepared by the same method as in Example 14.

Layer configuration: alignment film 1/light absorption anisotropic layer 1/protective layer 1/pressure sensitive adhesive layer/support

### (2) Preparation of Phase Difference Film Laminate X Having Twisted Structure

### <Preparation of Photo-Alignment Film>

A coating liquid 1 for forming a photo-alignment film was prepared with reference to the description of Example 3 in JP2012-155308A.

The coating liquid 1 for forming a photo-alignment film prepared in advance was applied to one surface of a cellulose acetate film “Z-TAC) (manufactured by FUJIFILM Corporation; film thickness: 40 m) using a bar coater. After the application, the coating film was dried on a hot plate at 120° C. for 2 minutes to remove the solvent, thereby forming a coating film. The obtained coating film was irradiated with polarized ultraviolet light (10 mJ/cm², using an ultra-high pressure mercury lamp) to prepare a TAC film 4 where the photo-alignment film A14 was formed.

### <Formation of Retardation Layer Having Twisted Structure Including Rod-Like Liquid Crystal Compound>

A composition 1 for forming a liquid crystal layer having the following composition was prepared.

The composition 1 for forming a liquid crystal layer was applied to the photo-alignment film AL4 using a bar coater to form a composition layer. The formed composition layer was heated to 110° C. on a hot plate, and was cooled to 60° C. to stabilize the alignment. Thereafter, the temperature was maintained at 60° C., the alignment was fixed by ultraviolet irradiation (500 mJ/cm², using an ultra-high pressure mercury lamp) in a nitrogen atmosphere (oxygen concentration: 100 ppm), the thickness was adjusted to 3.5 μm, and a retardation layer having a 90° twisted structure was formed to prepare a twisted layer type phase difference film laminate X having the following layer configuration. In the obtained retardation layer having the twisted structure, Δnd was 450 nm (wavelength: 550 nm).

Layer configuration: Z-TAC/photo-alignment film/retardation layer having twisted structure

Composition 1 for forming liquid crystal layer

| | |
|---|---|
| Liquid crystal compound R1 shown below | 84.00 parts by mass |
| Polymerizable compound B2 shown below | 16.00 parts by mass |
| Polymerization initiator P3 shown below | 0.50 parts by mass |
| Surfactant S3 shown below | 0.15 parts by mass |
| Chiral agent | 0.1 parts by mass |
| Hisolve MTEM (manufactured by TOHO | 2.00 parts by mass |
| Chemical Industry Co., Ltd.) | |
| NK Ester A-200 (manufactured by Shin- | 1.00 part by mass |
| Nakamura Chemical Co., Ltd.) | |
| Methyl ethyl ketone | 424.8 parts by mass |

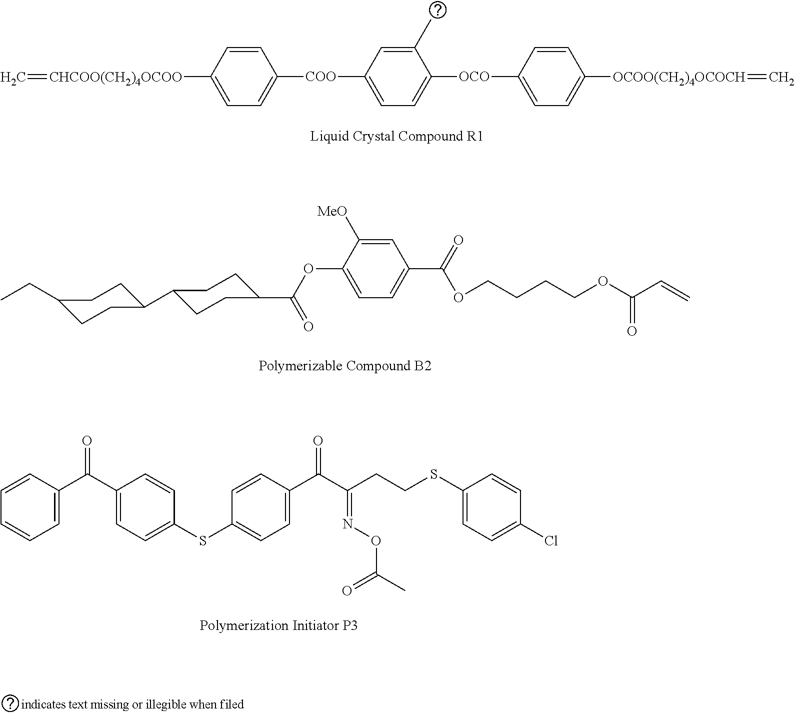

Surfactant S3 (a=67.5, b=32.5, c=0 Weight-Average Molecular Weight: 20,000)

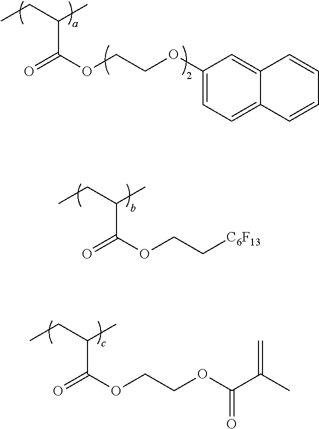

### Chiral Agent

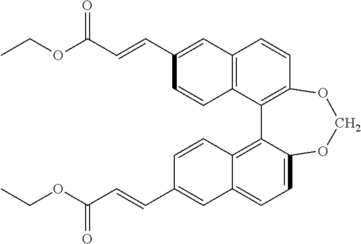

### (3) Lamination of Laminate X and Twisted Layer Type Phase Difference Film Laminate X

The surface of the Z-TAC of the twisted layer type phase difference film laminate X and the surface of the alignment film 1 of the laminate X were bonded to each other with a photocurable adhesive (ARONIX LCR, manufactured by Toagosei Co., Ltd.), and then the support on the laminate X side and the pressure sensitive adhesive layer were peeled off and removed to obtain an optical filter Y

Layer configuration: retardation layer having twisted structure/light alignment film/Z-TAC/photocurable adhesive/alignment film 1/light absorption anisotropic layer 1/protective layer 1

Next, the retardation layer having a twisted structure and the surface of the alignment film 1 of the second laminate X were bonded to each other using a photocurable adhesive (ARONIX LCR, manufactured by Toagosei Co., Ltd.), and then the support on the laminate X side and the pressure sensitive adhesive layer were peeled off and removed to obtain an optical filter Z.

Layer configuration: protective layer 1/light absorption anisotropic layer 1/alignment film 1/photocurable adhesive/twisted structure having retardation layer/photo alignment film/Z-TAC/photocurable adhesive/alignment film 1/light absorption anisotropic layer 1/protective layer 1

### (4) Preparation of Head-Mounted Display Y

A head-mounted display Y was prepared by the same method as in Example 14, except that the optical filter Z was used instead of the optical filter X.

### [Evaluation]

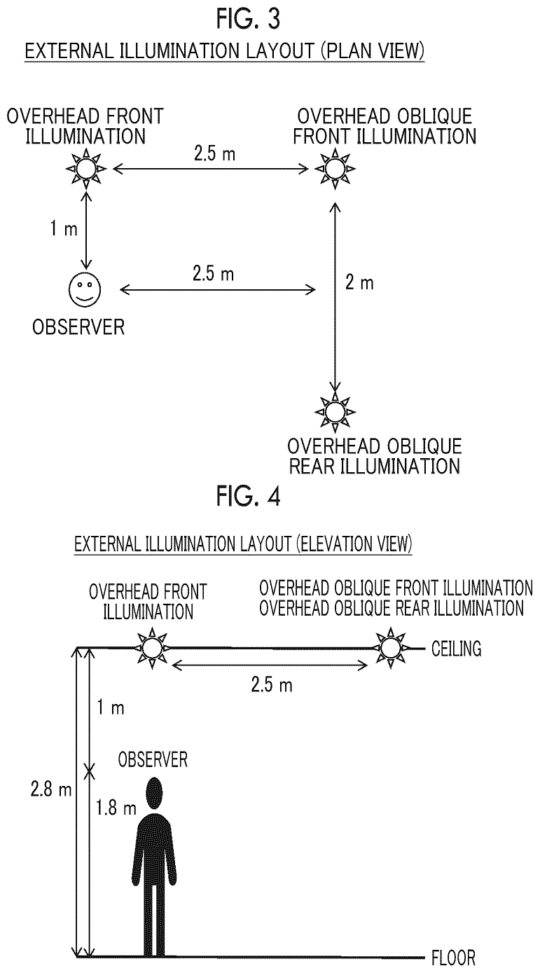

An observer having a height of 180 cm wore the prepared head-mounted display, and rainbow unevenness caused by external light from fluorescent lamps at three positions over the head were evaluated. In the evaluation system of the head-mounted display according to the embodiment of the present invention, the positions of the fluorescent lamps are shown in FIGS. 3 and 4, and the results are shown in Table 2.

Table 2 shows the visibility through the AR glasses, that is, the visibility of the background.
0: rainbow unevenness was clearly visible
1: rainbow unevenness was visible
2: rainbow unevenness was weakly visible
3: rainbow unevenness was slightly visible
4: rainbow unevenness was very slightly visible
5: rainbow unevenness was totally invisible

TABLE 2

| | | | | Absorption axis | Slit direction | | |
|---|---|---|---|---|---|---|---|
| | | | | direction of | of diffraction element | | |
| | | | | polarizer with | with respect to | | Observation |
| | Head- | | | respect to | horizontal direction | | surface side |
| | mounted | Optical | Optical filter | horizontal | Intermediate | Emission | Optical |
| | display | filter | configuration | direction | element | element | filter |
| Example 14 | X | X | PVA polarizer/Laminate X | 0° | 10 | 76 | |
| Example 15 | Y | Y | Twisted layer type phase | — | 10 | 76 | |
| | | | difference film laminate X | | | | |

| | Observation | | | | | |
|---|---|---|---|---|---|---|
| | surface side | | | | | |
| | Absorption | | | | | |
| | axis direction | Rainbow unevenness | | | | |
| | of polarizer | | Overhead | Overhead | | |
| | with respect | | oblique | oblique | Normal- | visibility |
| | to horizontal | Overhead | front | rear | incidence | through the |
| | direction | front | direction | direction | transmittance | AR glasses |
| Example 14 | — | 5 | 3 | 0 | 33% | Sufficient |
| | | | | | | visibility |
| Example 15 | — | 5 | 5 | 0 | 63% | Excellent |
| | | | | | | visibility |

From the results shown in Table 2, it was found that the head-mounted displays manufactured in Examples 14 and 15 had sufficient visibility of the background and rainbow unevenness caused by external light incident from the upper front side of the head was suitably suppressed.

### EXPLANATION OF REFERENCES

10: optical filter
12: polarizer
14: laminate
80: head-mounted display
82: light guide plate
90: incidence diffraction element
92: emission diffraction element
94: intermediate diffraction element
I₀: front external light
I₁: video light
L: oblique external light

What is claimed is:

1. A laminate comprising:
a protective layer;
a light absorption anisotropic layer;
an alignment film; and
a bonding layer, which are adjacent to each other in this order,
wherein the light absorption anisotropic layer contains a dichroic substance, a liquid crystal compound, and a vertical alignment agent,
an angle θ between a transmittance central axis of the light absorption anisotropic layer and a normal direction of a surface of the light absorption anisotropic layer is 0° or more and 45° or less, and
the bonding layer is a pressure sensitive adhesive layer or an adhesive layer.

2. The laminate according to claim 1,
wherein the light absorption anisotropic layer is a layer formed by fixing an alignment state of a liquid crystal composition containing the dichroic substance, the liquid crystal compound, the vertical alignment agent, and an additive having a crosslinkable group.

3. The laminate according to claim 2,
wherein the crosslinkable group is an active hydrogen reactive group, and the vertical alignment agent is an ionic vertical alignment agent.

4. The laminate according to claim 1,
wherein the vertical alignment agent includes an ionic vertical alignment agent and a vertical alignment agent having a boronic acid group.

5. The laminate according to claim 1,
wherein at least one of the protective layer or the alignment film contains an additive having an active hydrogen reactive group.

6. The laminate according to claim 1,
wherein a content of the dichroic substance contained in the light absorption anisotropic layer is 20 to 650 mg/cm³.

7. The laminate according to claim 1,
wherein an alignment degree of the light absorption anisotropic layer at a wavelength of 550 nm is 0.90 or more.

8. The laminate according to claim 1,
wherein a difference in alignment degree of the light absorption anisotropic layer at wavelengths of 450 nm, 550 nm, and 650 nm is 0.025 or less.

9. The laminate according to claim 1,
wherein a haze value of the light absorption anisotropic layer is 0.3% or less.

10. The laminate according to claim 1,
wherein a thickness of the light absorption anisotropic layer is 1.5 μm or more.

11. The laminate according to claim 2,
wherein the dichroic substance contained in the liquid crystal composition is a compound having a polymerizable group.

12. The laminate according to claim 1,
wherein at least one of the protective layer or the alignment film is any of a polyvinyl alcohol-based resin or an acrylate-based resin.

13. The laminate according to claim 1,
wherein the alignment film contains any one of a polyvinyl alcohol-based resin, a cinnamoyl group-containing resin, or an epoxy resin.

14. The laminate according to claim 1,
wherein the protective layer is an acrylic resin film consisting of a polymer of a polyfunctional (meth)acrylate.

15. The laminate according to claim 1, further comprising at least one layer of a polarizer layer, an antireflection layer, or a retardation layer.

16. The laminate according to claim 15,
wherein the polarizer layer is a coating type polarizer layer.

17. The laminate according to claim 2,
wherein the vertical alignment agent includes an ionic vertical alignment agent and a vertical alignment agent having a boronic acid group.

18. The laminate according to claim 2,
wherein at least one of the protective layer or the alignment film contains an additive having an active hydrogen reactive group.

19. The laminate according to claim 2,
wherein a content of the dichroic substance contained in the light absorption anisotropic layer is 20 to 650 mg/cm³.

20. The laminate according to claim 2,
wherein an alignment degree of the light absorption anisotropic layer at a wavelength of 550 nm is 0.90 or more.
